(19) United States
(12) Patent Application Publication
(10) Pub. No.: US 2024/0279480 A1
(43) Pub. Date: Aug. 22, 2024

(54) METHOD AND APPARATUS FOR RECOVERY AND REUSE OF TAIL GAS AND FLUE GAS COMPONENTS

(71) Applicant: Cabot Corporation, Boston, MA (US)

(72) Inventors: Daxiang Wang, Dracut, MA (US); Wei-Ming Chi, Tomball, TX (US); David S. Crocker, Townsend, TN (US); Martin C. Green, Boxborough, MA (US); David M. Matheu, Somerville, MA (US); Rob Davies, Hingham, MA (US)

(21) Appl. No.: 18/570,411

(22) PCT Filed: Jun. 23, 2022
(86) PCT No.: PCT/US2022/034713

§ 371 Date: Dec. 14, 2023

Related U.S. Application Data
(60) Provisional application No. 63/214,497, filed on Jun. 24, 2021.
(60) Provisional application No. 63/240,062, filed on Sep. 2, 2021.

(51) Int. Cl. C09C 1/60; B01D 53/48; B01D 53/76

(52) U.S. Cl. CPC C09C 1/60; B01D 53/48; B01D 53/76; B01D 2257/108; B01D 2257/30; B01D 2257/504; B01D 2257/80

(57) ABSTRACT

A method to produce carbonblack includes, in a carbonblack reactor having combustion zone and a reaction zone and a feedstock injection zone therebetween, converting a portion of at least one hydrocarbon feedstock to carbon black in the presence of combustion gases generated by burning a fuel in an oxidation gas mixture containing low amounts of nitrogen to form a product stream in which carbon black is carried by hot gases. The carbon black is separated from the hot gas, which is then processed to produce a flue gas high in carbon dioxide and low in nitrogen at least a portion of which is redirected to at least one of the combustion zone, the reaction zone, and the feedstock injection zone.

### BACKGROUND OF THE INVENTION

### 1. Field of the Invention

This invention relates to methods and apparatus for recovering and reusing components of tail gas and flue gas produced in carbon black production and tail gas combustion processes.

### 2. Description of the Related Art

Carbonaceous fuels and other organic material are combusted in a wide variety of industrial processes. Furnace reactors, combustion engines, combustion chambers, boilers, furnaces, heaters, hot gas generators, burners, waste incinerators, and the like, are used to combust carbonaceous fuels. This combustion equipment may be used to make energy, incinerate waste and byproduct materials, or both. During a typical combustion process within a furnace or boiler, for example, a hydrocarbon feedstock or fuel is combusted in the presence of oxygen or other oxidizing gas, and a flow of a combustion exhaust gas is produced. In some industries, such as in carbon black production, refinery operations, or petrochemical operations, exhaust gases generated in primary process units are conveyed to heaters or boilers for energy production or heat recovery. These operations can generate emissions, which can be subject to any applicable air quality controls or requirements.

A furnace carbon black producing process, for example, typically employs a furnace reactor having a burner or combustion chamber followed by a reactor. A combustion fuel feed stream, typically a hydrocarbon gas stream such as natural gas, or the like, is combusted in the burner portion along with an oxidant feed gas stream such as air, oxygen, or oxygen enriched air to produce hot combustion gases which pass then to the reactor portion of the furnace. In the reactor, hydrocarbon feedstock is exposed to the hot combustion gases. Part of the feedstock is burned, while the rest is decomposed to form carbon black, hydrogen, carbon monoxide, and other gaseous products. The reaction products typically are quenched with water, and the resulting product stream, a mixture of carbon black and tail gas, is cooled, conveyed to a bag collector or other filter system, whereupon the carbon black content is separated from the tail gas. The recovered carbon black typically is finished to a marketable product, such as, for example, by pulverizing and wet pelletizing. Water from the pelletizing typically is driven off with a dryer, which may be gas-fired, oil-fired, process-gas fired such as with tail gas, or combinations of these. The dried pellets can then be conveyed from the dryer to bulk storage or other handling. The dryer also can generate gaseous emissions. The principal source of emissions in the carbon black furnace process typically is from the tail gas. Other than direct venting, tail gas emissions have been discharged using flares. The tail gas can contain combustible gas components. This tail gas may be advantageously combusted to generate heat for a dryer as described above or for other uses. Following combustion, the resulting flue gas typically may include carbon dioxide, water, nitrogen, oxygen, and other species. The carbon dioxide may be separated from the flue gas and sequestered to reduce greenhouse gas emissions. However, it is desirable to make more efficient use of various gas species present in the tail gas and flue gas. Moreover, it is desirable to increase the concentration of carbon dioxide in the flue gas to improve the efficiency of greenhouse gas separation processes prior to any discharge of the flue gas.

### SUMMARY OF THE INVENTION

In one aspect, a method to produce carbon black comprises, in a carbon black reactor comprising a combustion zone, at least one feedstock injection zone downstream of the combustion zone, and at least one reaction zone downstream of the first feedstock injection zone, converting in the reaction zone(s) a hydrocarbon feedstock to carbon black in the presence of combustion gases generated in the combustion zone by burning a fuel in an oxidation gas mixture comprising 20-85 vol % carbon dioxide, 15-80 vol % oxygen, at most 30 vol % water, and at most 35 vol % nitrogen, to form a first product stream comprising carbon black, carbon dioxide, carbon monoxide, water vapor, and hydrogen, wherein the fuel is a portion of the hydrocarbon feedstock or a separate fuel source and wherein at least a portion of the hydrocarbon feedstock is contacted with the combustion gases in the at least one feedstock injection zone. The method further includes adding water to the first product stream to at least partially halt the conversion and form a second product stream comprising carbon black, carbon dioxide, carbon monoxide, hydrogen, and water vapor, removing the carbon black from the second product stream to form a tail gas, decreasing the carbon monoxide and hydrogen content in at least a portion of the tail gas to produce a flue gas, decreasing the carbon monoxide and hydrogen content in at least a portion of the tail gas to produce a flue gas comprising at most 40 vol % nitrogen, and directing at least a first portion of the flue gas to at least one of the combustion zone, the at least one feedstock injection zone, and the at least one reaction zone.

The first product stream may further include sulfur-containing species, and removing water may further include removing at least a portion of the sulfur-containing species from the first portion of the flue gas, a second portion of the flue gas, or both. Decreasing may include combusting the tail gas, separating and recovering at least a portion of the hydrogen from the tail gas, or both. The first product stream and second product stream may each contain carbon monoxide, and decreasing may further include combusting the tail gas following separating and recovering. The method may further include removing water from the tail gas prior to removing hydrogen. The method may further include directing at least a portion of the tail gas to the combustion zone. The method may further include removing water from the tail gas prior to directing at least a portion of the tail gas, and the removed water may be directed for use in step (b).

The method may further include combining the first portion of the flue gas with an oxidation reagent prior to directing, wherein the oxidation gas mixture comprises the combined first portion of the flue gas and oxidation reagent, and the combined first portion of the flue gas and oxidation reagent may be directed to the combustion zone, the reaction zone, or both. The method may further include heating the first portion of the flue gas before combining. The method may further include heating the combined first portion of the flue gas and the oxidation reagent. The method may further include heating the first portion of the flue gas prior to directing. The method may further include combining the first portion of the flue gas with the hydrocarbon feedstock prior to directing, wherein the combined flue gas and hydrocarbon feedstock are directed to the at least one feedstock injection zone. The method may further include heating the combined first portion of the flue gas and hydrocarbon feedstock. The method may further include heating the first portion of the flue gas to form a hot flue gas and combining the hot flue gas with the hydrocarbon feedstock prior to directing. The method may further include heating the first portion of the flue gas with an energy source selected from a microwave, a plasma, and a resistive heating element.

The method may further include removing water from the first portion of the flue gas to produce a dewatered flue gas comprising at most 35 vol % water, and the removed water may be directed for use in step (b). The method may further include pelletizing at least a portion of the carbon black by combining the portion with a liquid, forming carbon black beads, and drying the carbon black beads to reduce the water content to at most 1 wt %, wherein drying comprises heating the dewatered flue gas and contacting carbon black beads with the heated dewatered flue gas. The method may further include diverting a portion of the dewatered flue gas and removing at least a portion of the carbon dioxide from the diverted dewatered flue gas. The method may further include either or both of condensing and storing the carbon dioxide removed from the diverted dewatered flue gas.

Where the flue gas is dewatered, the method may further include providing the oxidizing gas by allowing liquid oxygen to evaporate, wherein the method further comprises transferring thermal energy from the dewatered flue gas to the liquid oxygen. Removing the carbon black may include passing the second product stream through a filter that separates the second product stream into carbon black and tail gas, wherein the method further comprises using the dewatered flue gas to purge solid particulates from the filter. Removing the carbon black may include passing the second product stream through a cyclone separator, and the method may further include employing a portion of the dewatered flue gas to separate the tail gas and the carbon black in the cyclone separator. The method may further include compressing at least a portion of the dewatered flue gas, and removing the carbon black may further include passing the second product stream through a filter, and optionally using the compressed dewatered flue gas to clean the filter. Decreasing may include combusting the tail gas in a burner, and the method may further include using the compressed dewatered flue gas to clean the burner.

Adding water may further include adding at least a portion of the first portion of the flue gas to the first product stream to halt the conversion.

In another aspect, carbon black is formed using any combination or subcombination of the method steps outlined above.

In another aspect, an apparatus for producing carbon black includes a carbon black reactor including a combustion zone for combusting an oxidation gas mixture and a fuel to generate a heated gas stream, a first feedstock injection zone for injecting a hydrocarbon feedstock into the heated gas stream to form a product stream, a first reaction zone in which carbon black is formed in the product stream, a first quench injector, and a first quench zone in which the carbon black is at least partially quenched with quench fluid injected from the first quench injector into the product stream. The apparatus further includes a separator in fluidic communication with the first quench zone in which the carbon black is separated from the product stream to form a tail gas, a thermal oxidizer configured to combust the tail gas with additional oxidation gas to form a hot flue gas, and a first flue gas heat exchanger that removes thermal energy from the hot flue gas to form a cooled flue gas The outlet is in fluidic communication with and upstream of at least one of the combustion zone, the first feedstock injection zone, and the first reaction zone.

The apparatus may further include a scrubber cooler including a sulfur-species scrubber and a water condenser. The scrubber cooler is to remove sulfur-containing species and water from at least a portion of the cooled flue gas, thereby producing dewatered flue gas, and includes an outlet through which the dewatered flue gas is discharged. The outlet of the scrubber cooler may further be in fluidic communication with a heater. The apparatus may further include a carbon black pelletizer configured to receive at least a portion of the heated dewatered flue gas, which then dries carbon black pellets formed in the pelletizer. The separator may include a bag filter, and the apparatus may be operable to direct at least a portion of the dewatered flue gas to periodically purge particulate solids from the bag filter. The apparatus may further include a carbon capture system operable to remove at least a portion of carbon dioxide present in the dewatered flue gas.

The heat exchanger may be a boiler in which thermal energy from the hot flue gas is transferred to water. The apparatus may further include a compressor configured to receive the flue gas from the outlet and discharge compressed flue gas. The apparatus may be configured to direct at least a portion of the tail gas to the combustion zone. The apparatus may further include a condenser upstream of the combustion zone configured to remove water from the tail gas. The apparatus may further include a hydrogen removal device upstream of the combustion zone configured to remove hydrogen from the tail gas. The apparatus may further include a second quench injector and a second quench zone in which the at least partially quenched carbon black is further quenched with quench fluid injected from the second quench injector into the product stream.

The apparatus may further include a heater disposed between the outlet and the at least one of the combustion zone and the first reaction zone to heat at least a portion of the flue gas. The heater includes a microwave source, a plasma source, or a resistive heating element. The apparatus may further include a heat exchanger to receive the product stream from the first quench zone, wherein the heat exchanger is operable to exchange heat of the product stream with at least a portion of the flue gas to heat the portion of the flue gas to a temperature from 400 to 950° C.

The apparatus may be configured to combine at least a portion of the flue gas with the additional oxidation gas and direct the combined flue gas and additional oxidation gas to the thermal oxidizer. The combustion zone, the first reaction zone, or both, may be configured to receive the oxidation gas mixture, which in turn comprises a mixture of the portion of the mass of the cooled flue gas and an oxidation reagent. That is, a portion of the cooled flue gas may be further processed, for example, by removal of sulfur and/or containing species, removal of water vapor, heating, compression, or more than one of these, and the processed portion of the cooled flue gas is then combined with the oxidation reagent.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIG. 1 is a schematic diagram illustrating the operation of a carbon black manufacturing process according to various exemplary embodiments.

FIG. 2 is a schematic diagram illustrating the operation of a carbon black manufacturing process according to various exemplary embodiments.

FIG. 3 is a schematic diagram illustrating the operation of a carbon black manufacturing process according to various exemplary embodiments.

FIG. 4 is a schematic diagram illustrating exemplary processes for converting a tail gas from a carbon black manufacturing process to dewatered flue gas according to an exemplary embodiment.

FIG. 5 is a schematic diagram illustrating the operation of a carbon black manufacturing process according to various exemplary embodiments.

FIG. 6 is a schematic diagram illustrating the operation of a carbon black manufacturing process according to various exemplary embodiments.

FIG. 7 is a schematic diagram illustrating the operation of a carbon black manufacturing process according to various exemplary embodiments.

FIG. 8 is a schematic diagram illustrating the operation of a carbon black manufacturing process according to various exemplary embodiments.

FIG. 9 is a schematic diagram illustrating the operation of a carbon black manufacturing process according to the comparative examples.

FIG. 10 is a schematic diagram illustrating the operation of a carbon black manufacturing process according to an exemplary embodiment.

### DETAILED DESCRIPTION OF THE INVENTION

In one embodiment, a method to produce carbon black includes, in a carbon black reactor having a combustion zone, at least one feedstock injection zone downstream of the combustion zone, and at least one reaction zone downstream of the first feedstock injection zone, converting in the reaction zone(s) a hydrocarbon feedstock to carbon black in the presence of combustion gases generated in the combustion zone by burning a fuel in an oxidation gas mixture comprising 20-85 vol % carbon dioxide, 15-80 vol % oxygen, at most 30 vol % water, and at most 35 vol % nitrogen to form a first product stream comprising carbon black, carbon dioxide, carbon monoxide, hydrogen, and water vapor, wherein the fuel is a portion of the hydrocarbon feedstock or a separate fuel source, e.g. burner fuel 24. Water is added to the first product stream to substantially halt the conversion and form a second product stream comprising carbon black, carbon dioxide, carbon monoxide, hydrogen, and water vapor. Carbon black is removed from the second product stream to form a tail gas, which is processed to oxidize and optionally remove oxidizable species such as carbon monoxide and hydrogen to produce a flue gas comprising at most 40 vol % nitrogen, and at least a portion of the flue gas is directed to the at least one of the combustion zone, the at least one feedstock injection zone, and the at least one reaction zone. The flue gas may optionally be processed to reduce the concentration of SOₓ, NOₓ, and water vapor to produce a dewatered flue gas.

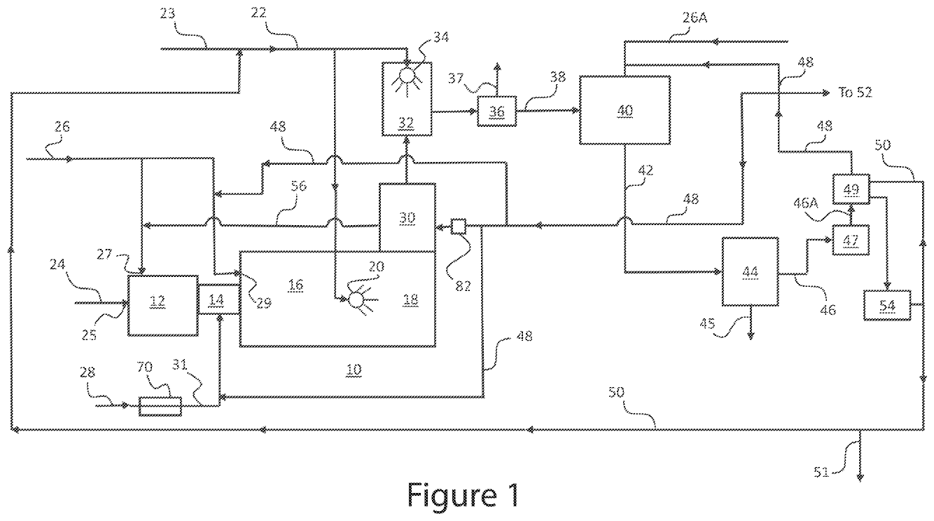

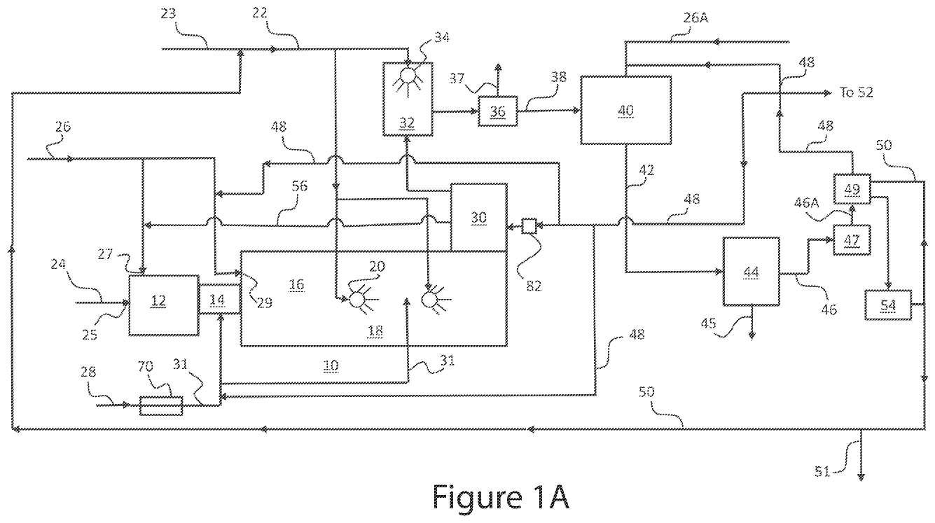

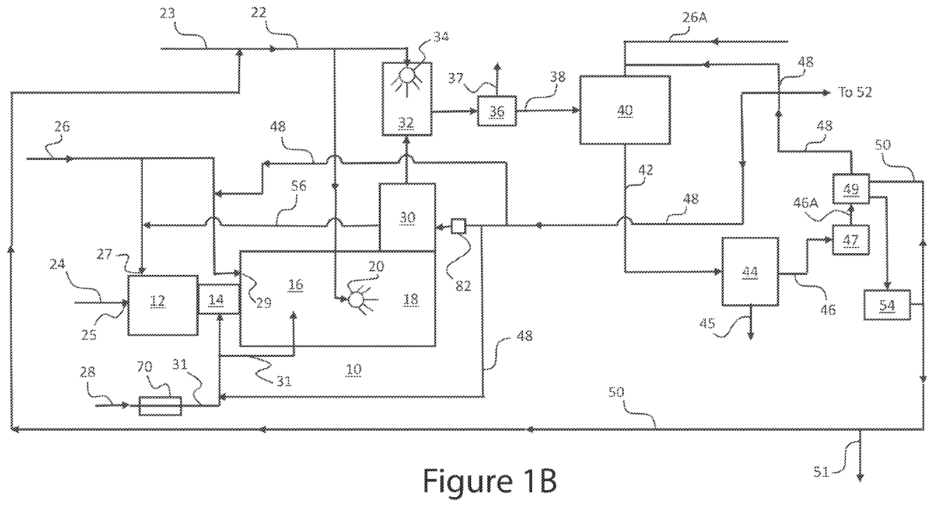

The methods and apparatus of the various embodiments and implementations can be used to modify any furnace carbon black reactor known to those of skill in the art. For example, these methods and apparatus may be used to modify furnace carbon black reactors such as those described in U.S. Pat. Nos. 3,922,335; 4,383,973; 5,190,739; 5,877,250; 5,904,762; 6,153,684; 6,156,837; 6,403,695; 6,485,693; 7,829,057; 8,871,173; and 10,829,642, the entire contents of all of which are incorporated by reference. In an exemplary embodiment shown in FIG. 1, carbon black is produced in a furnace carbon black reactor 10 comprising a combustion zone 12, a feedstock injection zone 14, a reaction zone 16 and a first quench zone 18 following first injector 20 for process water 22. Process water 22 may be pumped through first injector 20 and any subsequent injector(s) or may be injected through one or more of the injectors via a venturi mixer. To produce the carbon black, hot combustion gases are generated in combustion zone 12 by reacting liquid or gaseous burner fuel 24 and a suitable oxidation gas mixture comprising an oxidation reagent 26 and other gases described below. At least some of the components of the oxidation gas mixture enter combustion zone 12 via first oxidation gas inlet 27, and burner fuel 24 enters combustion zone 12 via fuel inlet 25. The hot combustion gas stream flows downstream from the combustion zone 12 through feedstock injection zone 14.

Carbon black yielding feedstock may be introduced into feedstock injection zone 14 radially, axially or both. Carbon black yielding feedstock is typically heated prior to introduction. As shown in FIG. 1, carbon black yielding feedstock 28 is heated in feedstock heater 70 to form heated feedstock 31. Heated feedstock 31 injected radially may be injected from a plurality of feedstock inlets disposed about a circumference of feedstock injection zone 14 and is injected in a transverse orientation to the hot combustion gas stream traveling from combustion zone 12 to reaction zone 16. Upon introduction, the heated feedstock 31 mixes with the hot combustion gas stream to form a product stream in which the carbon black yielding feedstock is pyrolyzed and carbon black is formed in reaction zone 16.

Optionally, and as shown in FIG. 1, additional oxidation gas mixture comprising oxidation reagent 26 is supplied to reaction zone 16 as a secondary oxidation stream via secondary oxidation gas inlet 29. The carbon black in the product stream can be quenched in one or more quench zones, e.g., first quench zone 18, each supplied by one or more injectors, e.g., first injector 20. Useful diameters and lengths of the various zones and the amount of water injected through the various injectors may be selected with reference to the above-indicated patents that are incorporated by reference. The effect of these parameters on the eventual morphology of the carbon black is well understood by those of skill in the art and does not change the operation of the various embodiments herein. Alternate carbon black reactor configurations are also possible, such as configurations employing two or more reaction zones optionally separated by a quench zone in which the reaction is partially quenched, with injection of additional carbon black generating feedstock in each subsequent reaction zone (FIG. 1A). Alternatively or in addition, additional feedstock 28 or heated feedstock 31 may be injected into reaction zone 16 without first quenching the reaction with process water 22 (FIG. 1B).

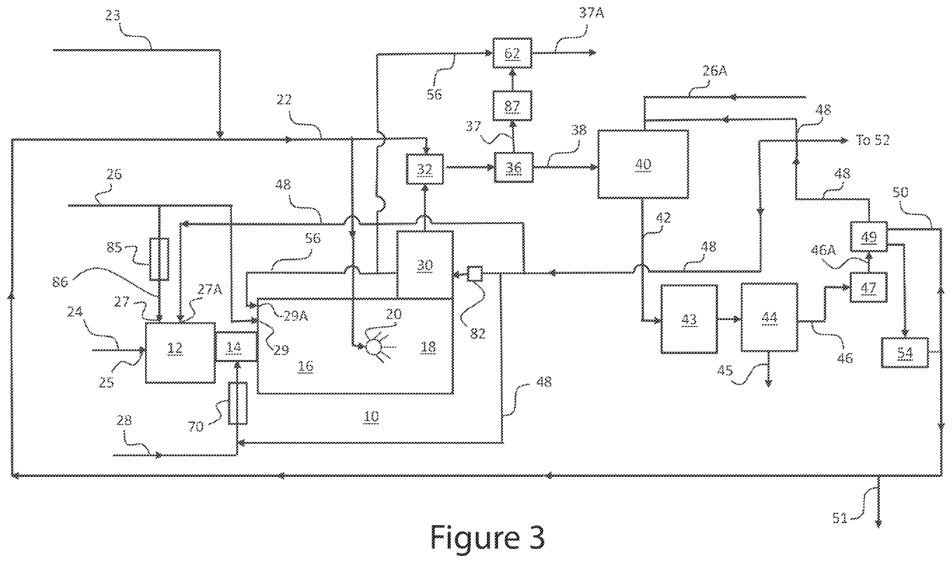

Among the fuels suitable for use in reacting with the oxidation gas mixture in combustion zone 12 to generate the hot combustion gas stream are included any readily combustible gas, vapor, and/or liquid stream such as natural gas, coal gas, biomass gas, biomass liquid, liquid fuel generated from a chemical process byproduct stream, hydrogen, carbon monoxide, methane, acetylene, alcohols, kerosene, or any gas having a lower heating value (LHV) greater than 2 MJ/Nm³. Combinations of these may also be employed. It is generally preferred, however, to utilize fuels having a high content of carbon-containing components, and, in particular, hydrocarbons. For example, any of the carbon black-yielding feedstocks listed below may also be employed as a burner fuel 24. The burner fuel 24 may be injected into combustion zone 12 at any temperature from its ambient temperature (i.e., without any heating or cooling) to 800° C. To facilitate the generation of hot combustion gases, oxidation reagent 26, the oxidation gas mixture comprising oxidation reagent 26, or other components of the oxidation gas mixture may be preheated before or after mixing, for example, to a temperature from 400-950° C. For example, in FIG. 3, oxidation reagent 26 is heated in heat exchanger 85.

The carbon black-yielding feedstock that can be employed with the present invention can include any hydrocarbon gas, liquid or oil feedstocks useful for carbon black production. Suitable liquid feedstocks include, for example, unsaturated hydrocarbons, saturated hydrocarbons, olefins, aromatics, and other hydrocarbons such as biomass-derived liquids, decant oil, coal tar derived liquids, asphaltene containing oils, kerosenes, naphthalenes, terpenes, ethylene tars, cracker residues, oils produced from recycled materials, or any combinations thereof. In general, any hydrocarbon-containing liquid with at least 60 wt % carbon content may be employed. Suitable gaseous feedstocks include, for example, natural gas, methane, ethylene, acetylene, and other C4-C6 hydrocarbon gases. Any of these feedstocks may be processed using techniques known to those of skill in the art to remove sulfur or other undesirable species prior to use. The carbon black-yielding feedstock 28 may be injected into feedstock injection zone 14 or subsequent injection zone(s) as discussed above at any temperature from its ambient temperature (i.e., without any heating or cooling) to 500° C. for liquid feedstocks or to 900° C. for gaseous feedstocks.

Also, any of the feedstocks for the described process schemes and methods can contain additional materials or compositions which are commonly used to make conventional carbon black. The method of the present invention can further include introducing at least one substance that is or that contains at least one Group IA and/or Group IIA element (or ion thereof) of the Periodic Table. The substance containing at least one Group IA and/or Group IIA element (or ion thereof) contains at least one alkali metal or alkaline earth metal. Examples include lithium, sodium, potassium, rubidium, cesium, francium, calcium, barium, strontium, or radium, or combinations thereof. Any mixtures of one or more of these components can be present in the substance. The substance can be a solid, solution, dispersion, gas, or any combinations thereof. More than one substance having the same or different Group IA and/or Group IIA metal (or ion thereof) can be used. If multiple substances are used, the substances can be added together, separately, sequentially, or in different reaction locations. For purposes of the present invention, the substance can be the metal (or metal ion) itself, a compound containing one or more of these elements, including a salt containing one or more of these elements, and the like. The substance can be capable of introducing a metal or metal ion into the reaction that is ongoing to form the carbon black product. For purposes of the present invention, the substance containing at least one Group IA and/or IIA metal (or ion thereof), if used, can be introduced at any point in the reactor, for example, prior to the complete quenching. The amount of the Group IA and/or Group IIA metal (or ion thereof) containing substance, if used, can be any amount as long as a carbon black product can be formed. The substance can be added in the same manner that a carbon black yielding feedstock is introduced. The substance can be added as a gas, liquid, or solid, or any combination thereof. The substance can be added at one point or several points and can be added as a single stream or a plurality of streams. The substance can be mixed in with the feedstock, fuel, and/or oxidant prior to or during their introduction.

In addition to carbon black, the product stream contains carbon dioxide, carbon monoxide, hydrogen, and water vapor. Water vapor is present before quenching and the product stream becomes more humid as a result of the quench. In addition, the product stream may include some nitrogen, acetylene, SOₓ, NOₓ, and other species that are typically generated during furnace carbon black production processes. Following quenching, the product stream containing hot carbon black can be passed through one or more heat exchangers, for example, through heat exchanger 30. The use of the heat extracted thereby is discussed in more detail below. As shown in FIG. 1, heat exchanger 30 transfers heat from the product stream to a gas, but heat exchanger 30 and any subsequent heat exchanger(s) may also be a boiler or other heat exchanger that transfers heat from the hot product stream to a liquid. After the product stream passes through the heat exchanger(s), a cooling zone 32 supplied with process water 22 by cooling zone injector 34 may provide an additional opportunity to control the temperature of the product stream prior to any separating and cooling steps described below. Alternatively or in addition, similar cooling zones may precede a particular heat exchanger to control the temperature of the product stream entering the heat exchanger.

After the product stream is quenched, it passes downstream into any conventional separating and cooling steps whereby the carbon black is recovered, denoted in FIG. 1 as separator 36. Separator 36 may include devices such as a bag filter, ceramic filter, cyclone separator, other devices known to those of skill in the art for separating particulates from a gas stream. or a combination of two or more of these. Separation of the quenched product stream results in two product streams, carbon black 37 and tail gas 38. One of skill in the art will recognize that small amounts of tail gas may be present in the stream of carbon black 37 and vice versa.

Carbon black 37 may be any conventional carbon black. For example, carbon black 37 may be any of the N-series carbon blacks in accordance with ASTM D-1765, for example, an N100, N200, N300, N500, N600, N700, N800, or N900 series carbon black. More particular examples of ASTM N-series carbon blacks include N110, N121, N134, N 220, N231, N234, N299, N326, N330, N339, N347, N351, N358, N375, N550, N660, N683, N762, N765, N774, or N990 carbon blacks. Alternatively or in addition, carbon blacks produced according to the embodiments provided herein may have a structure, as given by the oil adsorption number for the carbon black, (OAN, ASTM D-6556) from 30 to 450 mL/100 g, for example, 30 to 100 mL/100 g, from 100 mL/100 g to 200 mL/100 g, from 200 mL/100 g to 300 mL/100 g, or from 300 mL/100 g to 450 mL/100 g. Alternatively or in addition, and in combination with any of the structure values provided above, the carbon black may have a surface area (BET surface area, ASTM D-2414) from 5 to 1800 m²/g, for example, from 8 m²/g to 150 m²/g, from 150 m²/g to 350 m²/g, from 350 m²/g to 600 m²/g, from 600 m²/g to 900 m²/g, from 900 m²/g to 1300, or from 1300 m²/g to 1800 m²/g. The carbon black may be used in any end-use application in which carbon black is exploited, for example, as a pigment, reinforcing agent, filler, and/or thermal and/or electrical conductor and be useful in elastomers, plastics, polymers, toners, inks, batteries, adhesives, coatings, and the like.

In the embodiment shown in FIG. 1, the tail gas 38 proceeds to thermal oxidizer 40, where it is combusted with an oxidation gas mixture comprising oxidation reagent 26A, which may be the same or different composition as oxidation reagent 26, to produce a hot flue gas 42. Thermal oxidizer 40 may employ any technology known to those of skill in the art, for example, a direct fired thermal oxidizer, a combustor, an incinerator. Alternatively or in addition, a portion of tail gas 38 may be directed to a flare and burned without recovering energy from the resulting combustion. The energy in hot flue gas 42 may be used to provide heat in a variety of unit processes. In FIG. 1, the energy is used to heat water in boiler 44. The resulting steam 45 may be used to drive a turbine, to generate electricity, or to provide steam heat or steam for any other industrial process. Alternatively or in addition, the hot flue gas 42 may be passed through a heat exchanger in which the heat from hot flue gas 42 is used to heat a liquid or gas, for example, feedstock 28, oxidation reagent 26, or the oxidation gas mixture, and/or to dry carbon black pellets made from carbon black powder 37. As shown in FIG. 1, cooled flue gas 46 emerging from boiler 44 proceeds to a scrubber 47 where SOₓ and/or NOₓ, are removed. SOₓ removal may be accomplished via any method known to those of skill in the art. Exemplary SOₓ removal methods that may be used alone or in combination with one another include wet scrubbing with seawater or an aqueous slurry of limestone, lime, or other alkaline sorbent, spray-drying a mixture of the sorbent and the cooled flue gas 46, a dry sorbent injection process in which a sorbent material such as powdered hydrated lime is injected into a stream of cooled flue gas 46, and a wet sulfuric acid process such as that described in U.S. Pat. No. 5,108,731, the contents of which are incorporated herein by reference. Exemplary NOₓ removal processes include injection of ammonia or urea into a cooled flue gas 46 stream and selective catalytic reactor (SCR) processes known to those of skill in the art, including but not limited to methods described in U.S. Pat. No. 9,192,891, the entire contents of which are incorporated herein by reference. Alternatively to or in addition to scrubber 47, a selective non-catalytic reactor (SNCR) process including but not limited to methods described in the '891 patent may be used to remove NOₓ from hot flue gas 42. Because SCR and SNCR processes operate most efficiently in particular temperature ranges familiar to those of skill in the art (typically 275-500° C. and 900-1050° C., respectively), these processes may be situated in any appropriate point in the process between thermal oxidizer and scrubber 47. For example, SNCR 43 may be situated between thermal oxidizer 40 and boiler 44, with only SOₓ removal occurring in scrubber 47 (FIG. 3). Alternatively or in addition, a series of boilers and/or other heat exchangers may be substituted for boiler 44, with appropriate SCR and/or selective non-catalytic reactor (SNCR) processes incorporated at appropriate locations before or between the staged heat recovery systems. Alternatively or in addition, a catalytic process such as that described in EP2561921, the contents of which are incorporated herein by reference, or commercially available processes such as the SNOX™ process from Haldor Topsoe may also be employed. Any apparatus known to those of skill in the art for operating a scrubber may be employed, including a spray tower, a tray or plate tower, or a bed of packing material such as a ceramic or stainless steel that enhances contact between the scrubbing chemicals and the gas being scrubbed, e.g., cooled flue gas 46.

While oxidation reagent 26 and oxidation reagent 26A may include air, the oxidation reagent preferably does not include substantial amounts of nitrogen such as are found in air. For example, oxidation reagent 26 and/or oxidation reagent 26A may comprise 80-100% oxygen by volume, for example 90-100 vol % oxygen. Such oxygen may be compressed oxygen or more preferably liquified oxygen which has been allowed to evaporate. Alternatively or in addition, oxidation reagent 26 and/or oxidation reagent 26A may be produced from air or other gases using pressure swing adsorption or other methods known to those of skill in the art such as cryogenic air separation processes to increase the oxygen gas concentration. Such processes may leave small amounts of nitrogen, argon, or other gases in oxidation reagent 26 and/or oxidation reagent 26A. In some embodiments, oxidation reagent 26 comprises up to 40 vol % nitrogen, for example, 2 vol %-30 vol %, 3 vol %-20 vol %, or 5 vol %-10 vol % nitrogen. The less nitrogen employed in the oxidation reagent 26 and/or oxidation reagent 26A, the more concentrated the resulting dewatered flue gas 48 will be in carbon dioxide. Recycling the flue gas through the furnace carbon black reactor 10 can partially or completely obviate the use of air or other externally provided gases as a diluent for oxidation reagent 26 and/or oxidation reagent 26A, e.g., as a part of the oxidation gas mixture, further reducing the use of nitrogen in the system.

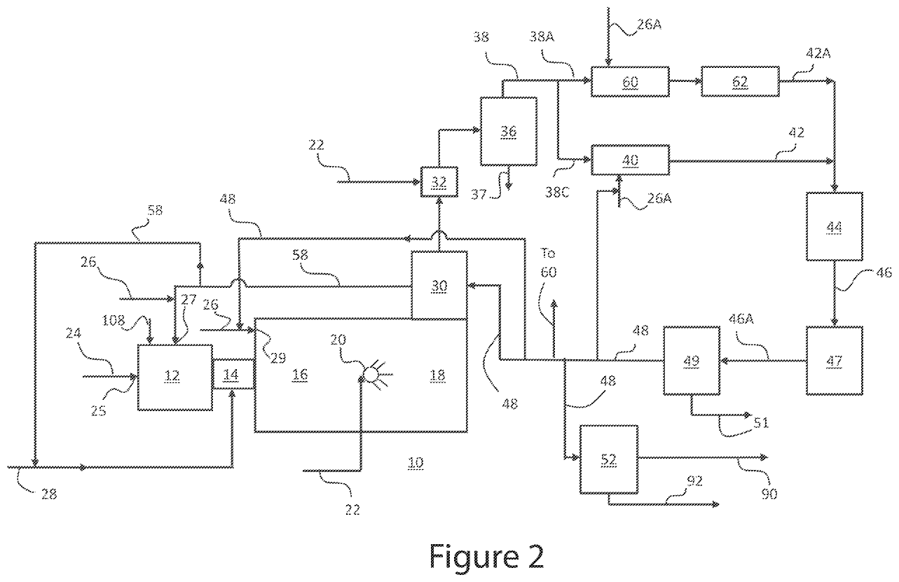

The oxidation reagent 26 employed in carbon black reactor 10 may be different than the oxidation reagent used in the downstream processes to process tail gas 38. For example, an alternative oxidation reagent 26A, which may be air or pressurized air, may be used to supply thermal oxidizer 40 (see FIG. 2). Alternatively or in addition, the alternative oxidation reagent 26A may be used in either or both of tail gas burner 60 or thermal oxidizer 40 (FIG. 2).

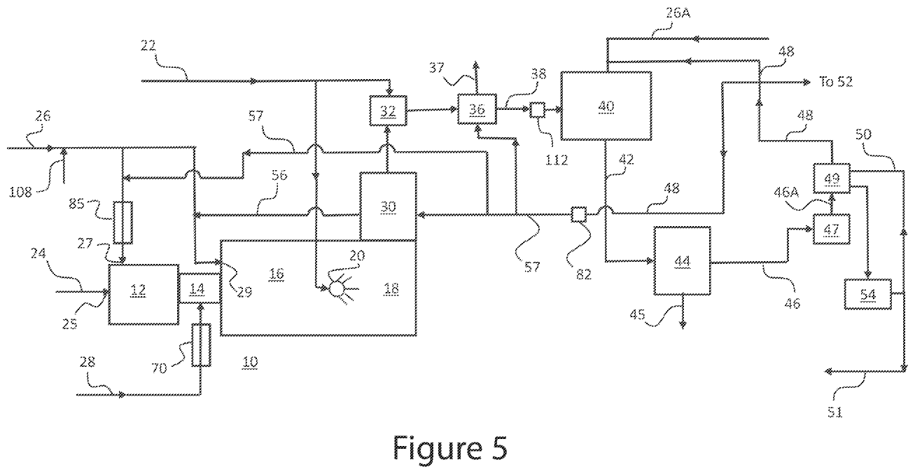

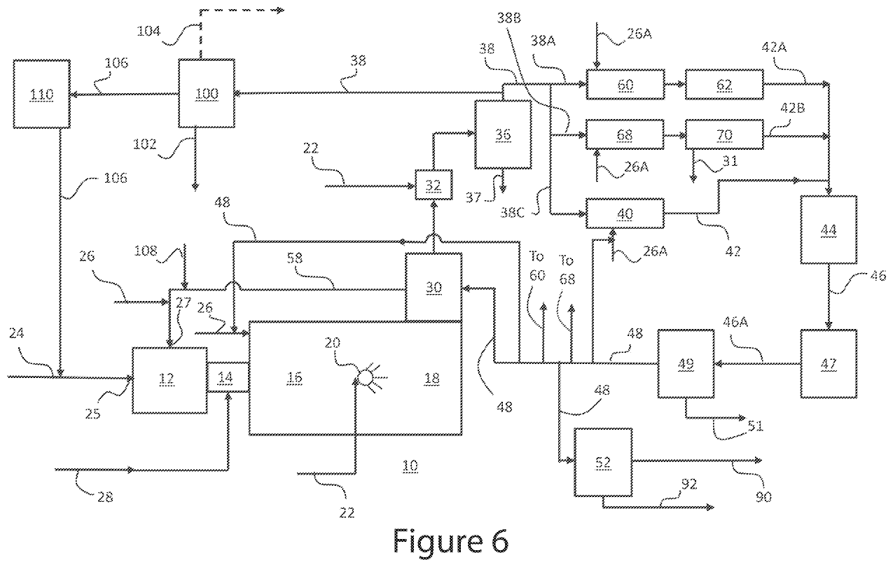

Alternatively or in addition, additional carbon dioxide from a separate source may be directed into combustion zone 12 and/or reaction zone 16. For example, carbon dioxide 108 may be combined with oxidation reagent 26 (FIG. 5) or dewatered flue gas 48 (see FIG. 6) prior to being directed into combustion zone 12 and/or reaction zone 16. Alternatively or in addition, it may be directed into either combustion zone 12 (FIG. 2), reaction zone 16, or both, separately from one or more components of the oxidation gas mixture.

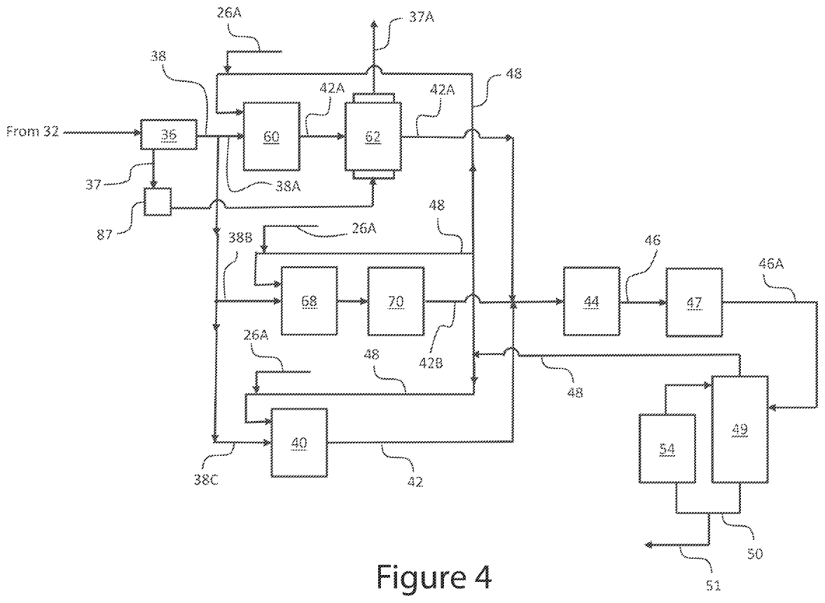

In an alternative embodiment, tail gas 38 may be directed to several parallel processes in which tail gas 38 is processed and the energy therein exploited. As shown in FIG. 4, tail gas 38 is divided into three streams 38A, 38B, and 38C. Stream 38A is directed to a tail gas burner 60 to be burned with an oxidation gas mixture formed by combining oxidation reagent 26A with dewatered flue gas 48. From tail gas burner 60, hot flue gas 42A is directed to dryer 62 for indirect drying of carbon black 37. The hot flue gas 42A is then directed to boiler 44. Stream 38B is directed to a firing box 68 of a feedstock heater 70 to be burned with the assistance of an oxidation gas mixture formed by combining oxidation reagent 26A with dewatered flue gas 48. The resulting hot gases are directed to feedstock heater 70, where feedstock 28 is preheated to a desired temperature then fed to feedstock injection zone 14 as heated feedstock 31 (FIG. 1). Stream 38C is directed to thermal oxidizer 40. Hot flue gas stream 42A from dryer 62, hot flue gas stream 42B from feedstock heater 70 and hot flue gas 42 from thermal oxidizer 40 can be combined and fed to boiler 44, from which cooled flue gas 46 proceeds to scrubber 47.

The scrubbed flue gas 46A emerging from scrubber 47, which may have any water vapor content resulting from the previous unit processes, e.g., 40-50 vol %, is then dewatered in gas dryer 49. Gas dryer 49 may employ apparatus known to those of skill in the art for dewatering gases, including both direct and indirect methods. Direct methods include use of cooling water to contact scrubbed flue gas 46A in a cooling scrubber or in a venturi mixer and scrub tank. Alternatively, a cooling reagent such as water, ammonia, glycol, etc., may be used to dewater the scrubbed flue gas 46A in a heat exchanger, with the cooling reagent recycled through a condenser to remove the heat transferred from the scrubbed flue gas 46A. The cooled water 50 may be discharged as wastewater 51 and/or recycled for use as at least a portion of process water 22. As shown in FIG. 1, water from gas dryer 49 is first cooled in cooler 54 prior to discharge or recycling, and a portion of the resulting cooled water 50 is directed to gas dryer 49 to dewater scrubbed flue gas 46A. FIG. 1 also shows domestic water feed 23 combined with cooled water 50 to form process water 22. Alternatively, all of process water 22 may be made up from domestic water feed 23. Upon discharge from gas dryer 49, the resulting dewatered flue gas 48 may have at most 35 vol % water vapor, for example, at most 30 vol % water vapor, at most 25 vol % water vapor, at most 20 vol % water vapor, or from 2 vol % water vapor to 15 vol % water vapor. Alternatively or in addition, dewatered flue gas 48 may be further dried by other methods known to those of skill in the art such as adsorption/desorption over a desiccant loaded vessel(s) to bring the amount of water vapor to at most 2 vol %, for example, at most 1 vol %, at most 0.5%, or from 0.2 vol % to 1.5 vol %. Dewatered flue gas 48 may have at most 40 vol % nitrogen, for example, at most 30 vol % nitrogen, at most 20 vol % nitrogen, at most 15 vol % nitrogen, at most 10 vol % nitrogen, at most 5 vol % nitrogen, at most 3 vol % nitrogen, at most 1 vol % nitrogen, at most 0.5 vol % nitrogen, or at most 0.1 vol % nitrogen. Dewatered flue gas 48 may have at most 1000 ppm carbon monoxide, for example, at most 800 ppm or at most 500 ppm carbon monoxide. Dewatered flue gas 48 may have at most 15 vol % oxygen, for example, from 0.5 vol % to 12 vol %, from 1 vol % to 10 vol %, from 2 vol % to 7 vol %, from 0.2 vol % to 5 vol %, at most 3 vol % or at most 2 vol % oxygen. Dewatered flue gas 48 may have at least 30 vol % carbon dioxide, for example, from 40 vol % to 99 vol %, from 50 vol % to 98 vol %, from 60 vol % to 95 vol %, at least 70 vol %, at least 80 vol %, at least 90 vol % or at least 95 vol % carbon dioxide.

Dewatered flue gas 48 may be employed in several unit processes in the furnace carbon black reactor 10 and the downstream processing of the resulting carbon black and other by-products. For example, it may form part of the oxidation gas mixture in which burner fuel 24 is combusted in combustion zone 12. As shown in FIG. 1, it may be employed as a diluent for oxidation reagent 26 and/or oxidation reagent 26A to form the oxidation gas mixture introduced into thermal oxidizer 40, combustion zone 12, or the secondary oxidation stream introduced into reaction zone 16 or subsequent reaction zone(s) as described above. Alternatively or in addition, at least a portion of dewatered flue gas 48 may be pressurized. Depending on the desired pressure for subsequent unit processes, it may be advantageous to pressurize dewatered flue gas 48, e.g., before heating it in heat exchanger 30 or other heat exchangers associated with furnace carbon black reactor 10 and its downstream processes. In one embodiment, a pump or compressor 82 may be disposed upstream of heat exchanger 30 either after (as shown in FIG. 1) or before (as shown in FIG. 5) any dewatered flue gas 48 is diverted to secondary oxidation gas inlet 29. As shown in FIG. 1, dewatered flue gas 48 is employed without further heating in the secondary oxidation stream but is passed through compressor 82 and heat exchanger 30 to become heated compressed dewatered flue gas 56, which is combined with oxidation reagent 26 for introduction into combustion zone 12. Alternatively, dewatered flue gas 48 may be heated and/or compressed before it is employed in the secondary oxidation stream and/or not heated prior to introduction to combustion zone 12 (FIG. 3).

Alternatively or in addition, dewatered flue gas 48 may be combined with oxidation reagent 26 and the resulting oxidation gas mixture heated prior to introduction into combustion zone 12, reaction zone 16, or subsequent reaction zone(s) as described above. As shown in FIG. 5, compressed dewatered flue gas 57 is heated in heat exchanger 85 and introduced into reaction zone 16. Whether or not the dewatered flue gas 48 is heated and/or compressed, it may be introduced directly into reaction zone 16 (or subsequent reaction zone(s) as described above) or the combustion zone 12 without being first mixed with the oxidation reagent 26; in this embodiment, the oxidation gas mixture is formed, e.g., in combustion zone 12 or reaction zone 16. For example, in FIG. 3, dewatered flue gas 48 is injected into combustion zone 12 via second oxidation gas inlet 27A and compressed heated dewatered flue gas 56 is injected into reaction zone 16 via secondary oxidation gas auxiliary inlet 29A. In any of these embodiments, dewatered flue gas 48, either alone or in a mixture with oxidation reagent 26, may be brought to a temperature from 400 to 950° C. In an alternative embodiment, dewatered flue gas 48 is combined with a limited amount of oxidation reagent 26, heated, and then combined with additional oxidation reagent. The amount of oxidation reagent 26 may be limited to an amount that can be safely accommodated in the heater given the flammability of certain oxidation reagents, such as oxygen.

The compressed dewatered flue gas 57 may be used to support any process in furnace carbon black reactor 10 or the associated downstream processes shown in the various figures that require compressed gas. For example, the compressed dewatered flue gas 57 may be used to cool sight glasses or a pilot burner in carbon black reactor 10. Alternatively or in addition, it may be used to blow soot off of boiler 44 and/or thermal oxidizer 40. The compressed dewatered flue gas 57 may be used to blow soot off an SCR catalyst in scrubber 47. The increased carbon dioxide concentration also allows dewatered flue gas 48, preferably following compression to compressed dewatered flue gas 57, to be used as a process gas for cleaning separator 36 (FIG. 5), for example, as a purge/reverse flow gas, especially where a bag filter or other similar device is employed, or in a cyclone device employed in separator 36. The increased carbon dioxide concentration of the dewatered flue gas reduces the risk of combustion that would be present if air was employed in the hot separator 36.

Alternatively or in addition, the dewatered flue gas 48 may be used to further process the carbon black. Carbon black is frequently compressed into pellets to reduce dusting and ease handling. To improve the handling characteristics of the relatively fluffy carbon black, it is frequently agglomerated by various mechanical processes to produce pellets, either in the dry state or with the aid of a liquid pelletizing aid. Generally the carbon black particles are held together by weak forces. Processes for pelletizing carbon blacks to produce carbon black pellets are known in the art. For example, U.S. Pat. No. 2,065,371 to Glaxner describes a wet pelletization process whereby the fluffy carbon black and a liquid such as water are combined and agitated until generally spherical carbon black beads are formed. Typical carbon black pellets are about a millimeter in size. In addition to water, a wide variety of binder additives are known to be useful in the wet pelletization process to further improve the pellet handling characteristics of the fluffy carbon blacks. Such additives include but are not limited to hygroscopic organic liquids such as ethylene glycol, carbohydrates (e.g., sugar, molasses, soluble starches, saccharides, lignin derivatives), rosin, sulfonate and sulfate anionic surfactants, fatty amine ethoxylate nonionic surfactants, sodium ligno sulfonates, silanes, sucrose, alkyl succinimides, alkylated succinic esters, and polyethylene oxide-co-polydimethyl siloxane surfactants. The beads are then dried to reduce the water content to at most 1% to form carbon black pellets. The dewatered flue gas 48 may be heated and used to dry the carbon black pellets through direct contact in the dryer. Dewatered flue gas 48 may be heated in heat exchanger 30 or using alternative heating methods as described below. For example, in FIG. 3, carbon black 37 is processed in pelletizer 87 and then contacted with heated compressed dewatered flue gas 56 in dryer 62 to form dried carbon black pellets 37A. Direct contact is possible because of the low flammability and low reactivity of heated compressed dewatered flue gas 56, while hot air has higher oxygen content and can create as safety risk if brought into direct contact with the combustible hot carbon black, and tail gas flammability can create a safety risk if air leaks into a dryer where hot tail gas contacts the carbon black pellets. The reactivity of either air or tail gas can affect the carbon black properties that may be detrimental to quality. For example, in FIG. 4, dryer 62 operates by indirect contact between pellets of carbon black 37 and hot flue gas 42A. For example, hot flue gas 42A may be passed through a jacket around a pipe or other enclosure that separates carbon black 37 from hot flue gas 42A.

The enhanced carbon dioxide concentration of dewatered flue gas 48 provides several advantages for the operation of furnace carbon black reactor 10 and downstream processes for collecting carbon black and other byproducts. In one embodiment, at least a portion of dewatered flue gas 48 may be diverted to a carbon capture system, e.g. carbon capture system 52. The increased partial pressure of carbon dioxide in dewatered flue gas 48 can improve the efficiency of carbon capture system 52. Carbon capture system 52 may include any carbon dioxide separation, utilization, sequestration and/or storage system known to those of skill in the art, for example, a physical adsorption based process (for example, using activated carbon, methanol, glycol, or other solvents that can engage in van der Waals interactions with carbon dioxide), a chemical absorption process (for example, employing an amine-based solvent, inorganic alkaline solutions such as potassium carbonate or sodium carbonate, or other chemicals that can form a weak chemical bond with carbon dioxide and be easily regenerated), and/or a membrane separation process (for example, using ceramic or zeolite membranes). Physical adsorption processes include but are not limited to thermal swing adsorption, pressure swing adsorption, and partial pressure swing adsorption. Carbon dioxide separation may also include drying processes, for example, by using a chiller, pressure swing adsorption, or other suitable process to remove water and then condensing carbon dioxide while removing lower boiling point gases such as oxygen and argon. Carbon dioxide separation processes may also remove oxygen, for example, excess oxygen that was not consumed in thermal oxidizer 40. Following separation, carbon dioxide 90 (FIG. 6) may be injected into an underground saline aquifer or other carbon sequestration aquifer, with other remaining gases (mostly water and oxygen, with small amounts of nitrogen and other gases) 92 discharged. Other methods for carbon dioxide storage known to those of skill in the art may be employed as well. Alternatively or in addition, the carbon dioxide may be used for industrial and/or commercial processes such as enhanced oil recovery, promoting fermentation and other biological processes, manufacture of building materials, fire extinguishers, beverage production, greenhouse-based agriculture, and other manufacturing and industrial processes that employ carbon dioxide as a process gas or use it as a raw material. Alternatively or in addition, liquid oxygen, e.g., designated for use as oxidation reagent 26, may be used as a cold reservoir to remove heat from and liquify carbon dioxide. Alternatively or in addition, the heat exchange between the enriched carbon dioxide stream and the liquid oxygen may be configured to help evaporate the liquid oxygen for use as oxidation reagent 26. In this manner, even the limited amount of thermal energy remaining in the carbon dioxide enriched stream following carbon dioxide separation may be exploited. The increased concentration of carbon dioxide in dewatered flue gas 48 reduces the amount of other gases that need to be separated from dewatered flue gas 48 prior to or in the course of carbon capture processes. Thus, the higher concentration of carbon dioxide in dewatered flue gas 48 can reduce the necessary size of the components of carbon capture system 52.

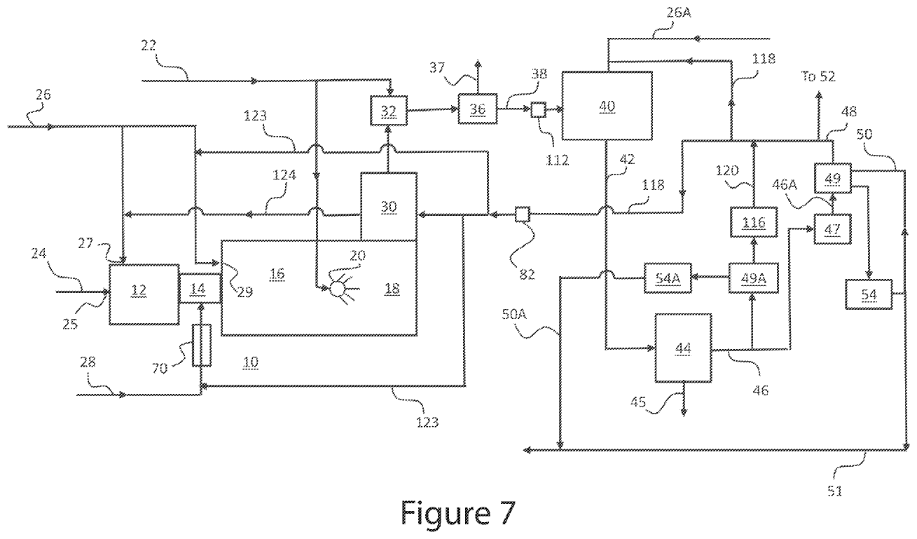

Alternatively or in addition, at least a portion of cooled flue gas 46 may be diverted and blended with dewatered flue gas 48 before the combined flue gas stream is used in the various combustion processes described herein. For example, in FIG. 7, a portion of cooled flue gas 46 is diverted to gas dryer 49A to remove water which is then cooled in cooler 54A to produce cooled water 50A. Cooled water 50A may be recycled to gas dryer 49A in the same manner as cooled water 50 is recycled to gas dryer 49 or may be used as part of process water 22. In FIG. 7, cooled water 50A is blended with waste water 51 and discharged. The dried, cooled flue gas emerging from gas dryer 49A is preferably heated above 200° C. in heater 116 to form recycled flue gas 120 prior to being combined with dewatered flue gas 48 to form flue gas mixture 118. Flue gas mixture 118 may be employed in any combustion process described herein or in furnace carbon black reactor 10 in the same manner as dewatered flue gas 48. For example, flue gas mixture 118 may be combined with oxidation reagent 26 before or after (or without) additional heating, e.g., in heat exchangers 30 and/or 85, and injected into combustion zone 12 and/or reaction zone 16 or may be injected into combustion zone 12 and/or reaction zone 16 separately from oxidation reagent 26.

As for dewatered flue gas 48, flue gas mixture 118 may be compressed to achieve a desired pressure. For example, in FIG. 7, flue gas mixture 118 is pressurized in compressor 82 to produce compressed flue gas mixture 123, which is combined with carbon black yielding feedstock 28 and directed to feedstock heater 30 and also combined with oxidation reagent 26 and directed to reaction zone 16. Compressed flue gas mixture 123 is also passed through heat exchanger 30, and the resulting heated compressed flue gas mixture 124 is combined with oxidation reagent 26 and directed to combustion zone 12. In certain embodiments, it is not necessary to dewater cooled flue gas 46, in which case heater 116 may also be omitted. The amount of cooled flue gas 46 that may be diverted depends on whether cooled flue gas 46 is dewatered prior to being combined with dewatered flue gas 48 (which will change the partial pressure of water vapor), the amount of dewatered flue gas 48 diverted to carbon capture system 52, the composition of oxidation reagent 26 and oxidation reagent 26A, and the desired composition of the oxidation gas mixture. However, diversion of a portion of cooled flue gas 46 will reduce the size necessary for scrubber 47 and gas dryer 49. In certain embodiments, the hot flue gas 42 may be passed through SNCR 43 prior to boiler 44, reducing the amount of NOₓ in the cooled flue gas 46 that is diverted.

Alternatively or in addition, the dewatered flue gas 48 or flue gas mixture 118 may be used as an atomizing gas for the injection of carbon black yielding feedstock in feedstock injection zone 14 or subsequent feedstock injection zone(s) as described above (FIG. 1). In embodiments where additional feedstock is injected into one or more reaction zone(s) such as reaction zone 16, the dewatered flue gas 48 or flue gas mixture 118 may additionally be used as an atomizing gas. In either of these embodiments, it may be desirable to preheat dewatered flue gas 48 or flue gas mixture 118. In FIG. 2, a portion of dewatered flue gas 48 is passed through heat exchanger 30 to form heated dewatered flue gas 58, which is combined with oxidation reagent 26 and injected into combustion zone 12. Alternatively or in addition, dewatered flue gas 48 may be combined with feedstock 28 and the mixture passed through a heat exchanger, e.g., heat exchanger 70 (FIG. 3). In FIG. 2, heated dewatered flue gas 58 is combined with carbon black generating feedstock 28 and the resulting mixture is directed to feedstock injection zone 14. Flue gas mixture 118 may be employed in the same manner as dewatered flue gas 48 in any of these embodiments. For example, in FIG. 7, flue gas mixture 118 is compressed to form compressed flue gas mixture 123, which is combined with oxidation reagent 26 to form the oxidation gas mixture. Compressed flue gas mixture 123 is also heated in heat exchanger 30 to form heated compressed flue gas mixture 124, which is combined with oxidation reagent 26 and directed to the reaction zone 16.

Alternatively or in addition, the enhanced carbon dioxide content of dewatered flue gas 48 and/or flue gas mixture 118 enables additional techniques for heating the dewatered flue gas 48 and/or flue gas mixture 118 as desired, for example, prior to injection into combustion zone 12 or reaction zone 16, prior to mixing with oxidation reagent 26, or prior to use as an atomizing gas for carbon black yielding feedstock 28. This can reduce or eliminate the need for combustion techniques to heat carbon black yielding feedstock 28 or oxidation reagent 26. Because of the low hydrocarbon and limited oxidizing content of dewatered flue gas 48 and flue gas mixture 118, they can be heated not only by combustion methods but also by electrically powered methods such as resistive heating elements, microwaves, or a thermal plasma, e.g., a direct arc plasma. For example, dewatered flue gas 48 and flue gas mixture 118, with or without compression, may be directly heated with an electrically powered heating element that can supply energy at elevated temperature. Preferably, the heating element is fabricated form a corrosion- and high temperature-resistant material such as zirconia, molybdenum carbide, silicon carbide, and other such materials known to those of skill in the art. Likewise, microwaves or an electric current could be passed through dewatered flue gas 48 or flue gas mixture 118. The electric current creates a plasma; microwave heating may also create a plasma depending on the microwave energy.

Moreover, the use of dewatered flue gas 48 or flue gas mixture 118 as a carrier gas or as part of the oxidation gas mixture potentially reduces the amount of gas delivered to the combustion zone 12 in proportion to the desired amount of oxygen. While air is only about 21% oxygen by volume, a synthetic gas prepared with dewatered flue gas 48 or flue gas mixture 118, with or without compression and/or heating, and purified (e.g., compressed or liquified/evaporated) oxygen can have an arbitrary proportion of oxygen, reducing the total amount of gas needed and essentially concentrating the carbon black content of the product stream. The reduced amount of gas employed to carry the carbon black product can increase the reactor throughput by allowing more carbon black to be produced for a given volume of the product stream. Moreover, the enhanced carbon dioxide content of dewatered flue gas 48 or flue gas mixture 118 in comparison to air may increase the amount of carbon black that can be produced from a given amount of carbon black yielding feedstock (yield efficiency).

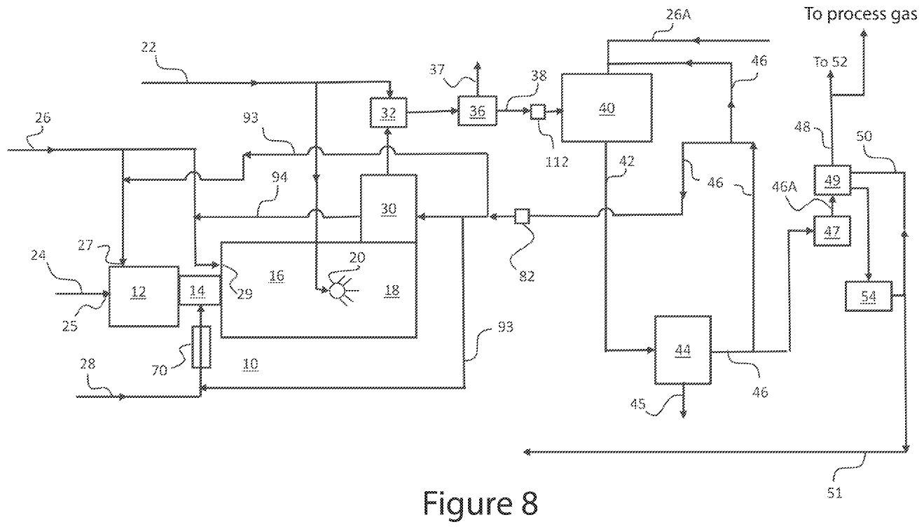

The oxidation gas mixture in which burner fuel 24 is combusted may include 20-85 vol % carbon dioxide, 15-80 vol % oxygen, at most 30 vol % water vapor, and at most 35 vol % nitrogen. Small amounts of other materials, such as argon, NOₓ, SOₓ, CO, and other components commonly found in compressed oxygen, compressed nitrogen, flue gases, and air may also be present. For example, the oxidation gas mixture can include 30-80 vol %, 40-75 vol %, 45-70 vol %, or 50-60 vol % carbon dioxide. Alternatively or in addition, the oxidation gas mixture can include 20-70 vol % or 25-60 vol % or 30-50 vol % oxygen. Alternatively or in addition, the oxidation gas mixture can include 0.1-20 vol %, 0.5-15 vol %, 1-10 vol %, or 2-5 vol % water. Alternatively or in addition, the oxidation gas mixture can include 2 vol %-35 vol % nitrogen, 4 vol %-25 vol % nitrogen, 5 vol %-15 vol %, or up to 10 vol % nitrogen.

Where at least a portion of cooled flue gas 46 is recycled, dewatered flue gas 48 need not be recycled to furnace carbon black reactor 10. Rather, dewatered flue gas 48 may be directed to carbon capture system 52, with a portion optionally diverted for use as a process gas (FIG. 8) as described above, e.g. to clean scrubber 47, to cool sight glasses, to dry carbon black pellets, in separator 36, etc. As shown in FIG. 8, cooled flue gas 46 is not even dried and reheated but is directly recycled to combustion zone 12, reaction zone 16, and thermal oxidizer 40 in the same manner as dewatered flue gas 48 or flue gas mixture 118. Likewise, cooled flue gas 46 may be used as diluent or carrier for oxidation reagent 26A in tail gas burner 60 or oxidation reagent 26 in feedstock heater 70. Cooled flue gas 46 may be heated, pressurized, and either combined with oxidation reagent 26 or separately injected into combustion zone 12 and/or reaction zone 16 in the same manner as described above for dewatered flue gas 48 and flue gas mixture 118. For example, in FIG. 8, cooled flue gas 46 is pressurized in compressor 82. The resulting compressed cooled flue gas 93 is combined with feedstock 28 and directed to feedstock heater 70 and also combined with oxidation reagent 26 and directed to combustion zone 12. The compressed cooled flue gas 93 is heated in heat exchanger 30 and the resulting heated compressed cooled flue gas 94 is combined with oxidation reagent 26 and directed to reaction zone 16.

The use of a low-nitrogen oxidation gas mixture also enables more beneficial use of the tail gas 38. For example, the reduced concentration of nitrogen also increases the proportion of hydrogen in the tail gas 38. Alternatively or in addition, at least a portion of tail gas 38 may be dewatered in tail gas processor 100 (FIG. 6) using methods known to those of skill in the art such as the methods described above for dewatering flue gas to create a dewatered tail gas. The resulting liquid water 102 may be directed to process water 22, waste water 51, or combined with cooled water 50 for use in gas dryer 49 (and gas dryer 49A, in embodiments where cooled flue gas 46 is dewatered and recycled).

Hydrogen can be optionally removed from the tail gas in tail gas processor 100 before or after dewatering using any method known to those of skill in the art, including hydrogen permeable membranes, pressure swing adsorption, and other swing methods. The resulting hydrogen 104 may be recycled for various uses including as rocket fuel, in fuel cells to generate electricity (for example, for zero-emissions vehicles), in hydrodesulfurization processes for fossil fuels, in the Haber-Bosch process for producing ammonia, as a reducing agent to recover metals such as tungsten and copper from various ores, and to hydrogenate oils and fats for use in food, to produce chemicals such as methanol and hydrogen peroxide, and in other industrial processes. Following dewatering and optional hydrogen removal, the processed tail gas 106 may be combusted, e.g., in a device similar to tail gas burner 60, firing box 68, or thermal oxidizer 40. In embodiments where hydrogen is removed from the tail gas 38, the primary combustible gas in the processed tail gas 106 will be carbon monoxide, further reducing the amount of oxidant, e.g., oxidation reagent 26A, required to combust the tail gas.

Alternatively or in addition, the increased concentration of hydrogen and carbon monoxide in tail gas 38 in comparison to a tail gas generated with the use of air in carbon black reactor 10 makes the tail gas 38, following dewatering, especially suitable for reuse as at least a portion of burner fuel 24 (FIG. 6). For example, at least a portion of the dewatered tail gas may be redirected to combustion zone 12, with any remaining dewatered tail gas optionally processed to remove hydrogen prior to combustion or other oxidation or removal of carbon monoxide. Alternatively, at least a portion of the tail gas 38 may be recycled directly to combustion zone 12 without dewatering and/or without hydrogen removal. Because the dewatered tail gas, following optional hydrogen removal, still contains carbon monoxide (in addition to any residual hydrogen), it may still be beneficially redirected to combustion zone 12. In any embodiment where at least a portion of tail gas 38, with or without one or more of dewatering and hydrogen removal, is recycled to combustion zone 12, a reduced amount of oxidation reagent 26A is required for thermal oxidizer 40 because a lower volume of gas is being processed. In addition, recycle of the tail gas results in a lower amount of flue gas to be processed in scrubber 47. FIG. 6 depicts tail gas processor 100 separate from the diversion of tail gas 38 to tail gas burner 60, firing box 68, and thermal oxidizer 40. However, it may be desirable to dewater and even remove hydrogen from tail gas 38 and utilize processed tail gas 106 in tail gas burner 60, firing box 68, and thermal oxidizer 40.

Alternatively or in addition, at least a portion of the tail gas 38 may be pressurized. Equipment using compressed tail gas can be operated at higher pressures or can be smaller, or both, since the volume of tail gas is less. For example, use of compressed tail gas from compressor 112 (FIG. 5) in thermal oxidizer 40 will result in a higher pressure for hot flue gas 42 and consequently dewatered flue gas 48. Alternatively or in addition, that portion of tail gas 38 that will be directed to combustion zone 12 may be compressed. It may be advantageous to dewater all or a portion of tail gas 38 prior to compression. For example, tail gas 38 may first be processed in tail gas processor 100 to reduce water vapor and optionally hydrogen content prior to compression as shown for compressor 110 (FIG. 6). Tail gas 38 may also be similarly processed before being directed to compressor 112.

### EXAMPLES

Two typical carbon black product grades production processes were simulated based on empirical furnace operation parameters, carbon black product yield correlations etc. The two types of CB grade simulated include a Semi-reinforced grade of ASTM N-500 and 600 series carbon blacks (low surface area, or LS carbon black) and reinforced grade of ASTM N-100 to 300 series carbon blacks (high surface area, or HS carbon black).

For all the production process simulated, similar feedstock and natural gas fuel are used. Their characteristics can be represented in Table 1 and Table 2 respectively.

TABLE 1
Natural gas fuel properties used in
the CB production process simulation

| Components | Composition (vol %) |
|---|---|
| CH₄ | 93.330% |
| C₂H₆ | 3.867% |
| Propane | 0.243% |
| Butane | 0.060% |
| Pentane | 0.059% |
| Hexane | 0.039% |
| N₂ | 0.437% |
| CO₂ | 1.965% |
| Lower heating value (LHV) (MJ/Nm³) | 36.32 |

TABLE 2
Feedstock properties used in the CB production process simulation

| Properties | Value |
|---|---|
| Elemental composition | Wt. % |
| H | 8.45% |
| C | 88.45% |
| N, O, S | Balance |
| Specific Gravity | 1.13 |

### Comparative Example 1: LS (Low Surface Area) Carbon Black Production

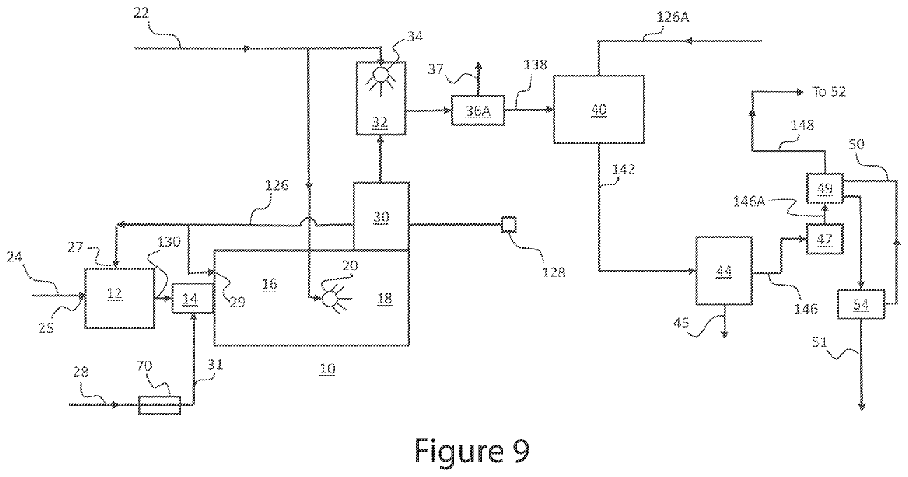

In this example, the carbon black product is produced using a furnace carbon black reactor 10 shown in FIG. 9. Natural gas is used as burner fuel 24 fired with combustion air 126 supplied through an air blower 128. The preheated combustion air 126 burns the natural gas in combustion zone 12 to form a primary flame and generate a gas (primary flame gas 130) that passes from the combustion zone 12 into the feedstock injection zone 14. Feedstock 28, decant oil as listed in Table 2, is preheated to 240° C. and then injected into the primary flame through one or more nozzles in feedstock injection zone 14 to produce a hot smoke stream containing the desired carbon black product entrained in a hot byproduct gas stream. Water is directed through first stage injector(s) 20 about 10-15 m downstream of feedstock injection zone 14 to terminate the reaction and then the quenched reactor product stream is passed through heat exchanger 30 to preheat ambient air to generate combustion air 126. The cooled reactor product stream is further cooled in cooling zone 32 to around 230° C. and transferred to a bag filter 36A to separate the solid carbon black 37 out and generate tail gas 138. Tail gas 138 with a substantial heating value is combusted in thermal oxidizer 40 using air 126A as oxidant to generate heat (about 29 MW in the model of this example) for process heating and/or for heat recovery for steam production. The combustion of tail gas 138 is controlled such that complete destruction of volatile organic compounds to meet applicable environmental regulations and simultaneously minimize the excess oxygen concentration in the hot flue gas 142 to maximize thermal efficiency and/or minimize flue gas flow rate to reduce the design capacity for the downstream air pollution control unit, e.g., an SNCR (not shown) and/or scrubber 47, including a gas dryer 49 with a cooling duty of about 17.6 MW to dewater the scrubbed flue gas 146A and form dewatered flue gas 148. Stream 148 is sent to CO₂ capture unit 52 to capture CO₂ from it for sequestration, enhanced oil recovery or other utilizations.

Table 3 summarizes the key process parameters for LS grade carbon black production following this process.

TABLE 3
Key process parameters for Example 1

| | Stream Name | | | |
|---|---|---|---|---|
| | Combustion | Burner | | |
| Parameter | Air 126 | Fuel 24 | Feedstock 28 | Primary Flame Gas 130 |
| Fluid type | Gas | Gas | Liquid | Gas |
| Gas flow, | 13.447 | 400 | 0 | 13.857 |
| Nm³/h | | | | |
| Gas flow, | 17.308 | 309 | 0 | 17.617 |
| kg/h | | | | |
| Temperature, | 500 | 20 | 240 | 1,156 |
| deg. C. | | | | |
| Liquid flow, | | | | |
| kg/h | 0 | 0 | 7,000 | 0 |

| | Stream Name | | | |
|---|---|---|---|---|
| | Reaction stream | | | |
| | passing from reaction | Total | Tail Gas 138 to | Process Air |
| | zone 16 to first | Quench | Thermal | 126A to burn |
| Parameter | quench zone 18 | Water 22 | Oxidizer 40 | Tail Gas 138 |
| Fluid type | Gas + Solid | Liquid | Gas | Gas |
| Gas flow, | 22,248 | 0 | 39,657 | 36,711 |
| Nm³/h | | | | |
| Gas flow, | 20,143 | 0 | 34.137 | 47,250 |
| kg/h | | | | |
| Temperature, | 1,339 | 20 | 230 | 0 |
| deg. C. | | | | |
| Liquid flow, | 0 | 13,994 | 0 | 0 |
| kg/h | | | | |
| Solid Flow, | 4,474 | | | |
| kg/h | | | | |

| | Stream Name | | | | |
|---|---|---|---|---|---|
| | | Cooled flue | | Wastewater | Dewatered |
| | | gas 146 | | 51 | flue gas 148 |
| | Hot Flue | exiting | Dewatered | from | to CO₂ |
| Parameter | gas 142 | boiler 44 | flue gas 148 | dewatering | Capture 52 |
| Fluid type | Gas | Gas | Gas | Liquid | Gas |
| Gas flow, | 71,388 | 71,388 | 49,429 | 0 | 49,429 |
| Nm³/h | | | | | |
| Gas flow, | 81,387 | 81,387 | 63,736 | 0 | 63,736 |
| kg/h | | | | | |
| Temperature, | 1,132 | 230 | 40 | 40 | 40 |
| deg. C. | | | | | |
| Liquid flow, | 0 | 0 | 0 | 17,652 | 0 |
| kg/h | | | | | |
| Solid Flow, | | | 0 | 0 | 0 |
| kg/h | | | | | |

TABLE 4
Composition and properties of several key
gas streams for Comparative Example 1

| | Stream Name | | | |
|---|---|---|---|---|
| | Primary | | | Dewatered Flue |
| Composition | Flame Gas | | Hot Flue | Gas 148 prior to |
| (vol. %) | 130 | Tail gas 138 | Gas 142 | CO₂ Capture |
| N₂ | 76.77% | 26.83% | 55.58% | 80.27% |
| O₂ | 14.44% | 1.5E−12 | 3.8E−02 | 5.45% |
| CO | 8.9E−08 | 9.37% | 0.00% | 0.00% |
| H₂ | 7.5E−08 | 15.75% | 0.00% | 0.00% |
| H₂O | 5.77% | 47.38% | 35.07% | 6.22% |
| CO₂ | 3.01% | 0.69% | 5.58% | 8.06% |
| CH₄ | 2.8E−32 | 4.6E−08 | 9.1E−30 | 0 |

In this comparative example, there will be 49,429 Nm³/h of dewatered flue gas 148 to be processed in the CO₂ capturing unit. This gas stream contains 8.06 vol. % of CO₂ (Table 4).

### Example 2: LS (Low Surface Area) Carbon Black Production According to an Exemplary Embodiment of the Invention

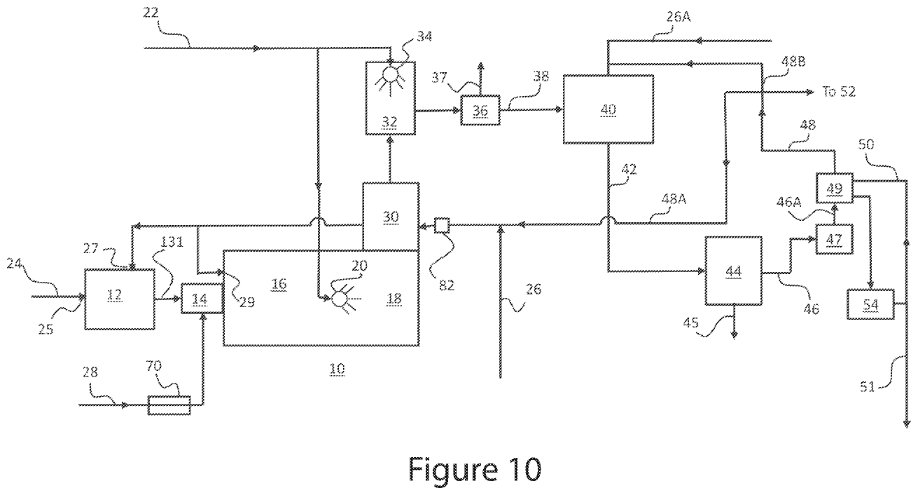

In this example, the carbon black product is produced using a furnace carbon reactor 10 having a similar configuration to that employed in Comparative Example 1 but employing flue gas recycling as shown in FIG. 10. Natural gas is used as burner fuel 24 fired with an oxidation gas mixture formed of a mixture of an oxygen stream as oxidation reagent 26 and dewatered flue gas 48A. In this example, the oxygen stream contains 3 vol % of N2 and 97 vol. % of O₂. The ratio of the oxygen and dewatered flue gas in the oxidation gas mixture is adjusted to target the primary flame temperature to be close to that used in Comparative Example 1. The flow rate of dewatered flue gas 48A is adjusted to target the stream flow of primary flame 131 close to that for Example 1.

The resulting tail gas 38 is also combusted with the oxidation reagent 26A of oxygen (97 vol. % of O₂ and 3 vol. % N2) mixed with dewatered flue gas 48B to target a desired flame temperature and level of excess oxygen concentration in the hot flue gas 42 and generate about 28.6 MW of thermal energy. Similar to Comparative Example 1, hot flue gas 42 from combustion of tail gas 38 will be cooled in boiler 44 to generate steam 45. After removing NOₓ and SOₓ to the desired permit level, the scrubbed flue gas 46A is dewatered at 40° C. (cooling duty for dewatering ˜19.9 MW). A slip stream of the resulting dewatered flue gas 48 is partially (48A) recycled back to mix with oxygen to form the oxidation gas mixture and preheated in heat exchanger 30 to the desired temperature before entering into the burner. Stream 48B is a slip stream of the dewatered flue gas 48, which is recycled back to mix with oxidation reagent 26A to be used as oxidant for thermal oxidizer 40. The balance of the dewatered flue gas 48 is sent to the CO₂ capturing unit 52 for CO₂ removal. The key parameters for this example are summarized in Table 5 below.

TABLE 5
Key Process Parameters for Example 2

| | Stream Name | | | | |
|---|---|---|---|---|---|
| | Oxidation | Dewatered | Oxidation | Burner | |
| | Reagent | Flue Gas | Gas | Fuel | Feedstock |
| Parameter | 26 | 48A | Mixture | 24 | 28 |
| Fluid type | Gas | Gas | Gas | Gas | Liquid |
| Gas flow, | 2,846 | 11,491 | 14,337 | 400 | 0 |
| Nm³/h | | | | | |
| Gas flow, | 4,049 | 21,072 | 25,121 | 309 | 0 |
| kg/h | | | | | |
| Temperature, | 20 | 40 | 700 | 20 | 240 |
| deg. C. | | | | | |
| Liquid flow, | 0 | 0 | 0 | 0 | 7,000 |
| kg//h | | | | | |

| | Stream Name | | |
|---|---|---|---|
| | Primary Flame Gas | | |
| | 131 passing from | Reaction stream | |
| | combustion zone 12 to | passing from reaction | |
| | feedstock injection | zone 16 to first quench | Total Quench |
| Parameter | zone 14 | zone 18 | Water 22 |
| Fluid type | Gas | Gas + Solid | Liquid |
| Gas flow, | 14,747 | 22,780 | 0 |
| Nm³/h | | | |
| Gas flow, | 25,430 | 27,956 | 0 |
| kg/h | | | |
| Temperature, | 1,116 | 1,339 | 20 |
| deg. C. | | | |
| Liquid flow, | 0 | 0 | 14,281 |
| kg//h | | | |
| Solid Flow, | 0 | 4,474 | |
| kg/h | | | |

| | Stream Name | | | |
|---|---|---|---|---|
| | | | Dewatered flue | Oxidation gas |
| | Tail Gas 38 to | Oxidation Reagent | gas 48B to | mixture to |
| | Thermal | 26A to thermal | Thermal oxidizer | thermal oxidizer |
| Parameter | Oxidizer 40 | oxidizer 40 | 40 | 40 |
| Fluid type | Gas | Gas | Gas | Gas |
| Gas flow, | 40,546 | 5,356 | 24,653 | 30,010 |
| Nm³/h | | | | |
| Gas flow, | 42,237 | 7,619 | 45,208 | 52,827 |
| kg/h | | | | |
| Temp. | 230 | 20 | 40 | 37 |
| deg. C. | | | | |
| Liquid | 0 | 0 | 0 | 0 |
| flow, kg/h | | | | |

| | | | Stream Name | | |
|---|---|---|---|---|---|
| | | Cooled | | Wastewater | Dewatered |
| | | flue gas 46 | | 51 | flue gas to |
| | Hot flue gas | exiting | Dewatered | From | CO₂ Capture |
| Parameter | 42 | boiler 44 | flue gas 48 | dewatering | 52 |
| Fluid type | Gas | Gas | Gas | Liquid | Gas |
| Gas flow, | 65,935 | 65,935 | 40,841 | 0 | 4,697 |
| Nm³/h | | | | | |
| Gas flow, | 95,064 | 95,064 | 74,892 | 0 | 8,613 |
| kg/h | | | | | |
| Temp., | 997 | 230 | 40 | 40 | 40 |
| deg. C. | | | | | |
| Liquid | 0 | 0 | 0 | 20,172 | 0 |
| flow, kg//h | | | | | |

TABLE 6
Composition and properties of several key gas streams for Example 2

| | Stream Name | | | | | |
|---|---|---|---|---|---|---|
| | Oxidation Gas | | | Oxidation | | |
| | Mixture to | Primary | | Gas Mixture | Hot | Dewatered |
| Composition | combustion | Flame | Tail | to Thermal | Flue | Flue |
| (vol. %) | zone 12 | Gas 131 | gas 38 | Oxidizer 40 | Gas 42 | Gas 48 |
| N₂ | 4.83% | 4.70% | 1.71% | 4.87% | 3.27% | 5.28% |
| O₂ | 22.10% | 16.00% | 0.00% | 20.23% | 2.20% | 3.55% |
| CO | 3.57E−07 | 1.39E−06 | 17.44% | 0.00% | 0.00% | 0.00% |
| H₂ | 1.76E−07 | 9.95E−08 | 5.35% | 0.00% | 0.00% | 0.00% |
| H₂O | 5.06% | 10.34% | 59.06% | 5.19% | 41.97% | 6.31% |
| CO₂ | 68.01% | 68.95% | 16.44% | 69.71% | 52.56% | 84.86% |
| CH₄ | 0 | 0 | 0 | 0 | 0 | 0 |

In this example, there will be 4,697 Nm³/h of dewatered flue gas that needs to be processes in the CO₂ capturing unit. This gas stream contains 84.86 vol. % of CO₂ (Table 6).

### Comparative Example 3: HS (High Surface Area) Carbon Black Production

In this Comparative Example 3, high surface area grade carbon black is produced using a conventional recipe as described in Example 1 but with a quench length of about 1-10 m. The carbon black product processing, tail gas combustion, energy recovery and flue gas treatment generally follow the same protocol as shown in Example 1. The key process parameters for this Example are summarized in Table 7 below. Combustion of tail gas 138 results in about 36.9 MW of thermal energy, and a cooling duty of about 25.6 MW is required to dewater the scrubbed flue gas 146A.

TABLE 7
Key process parameters for Example 3

| | Stream Name | | | |
|---|---|---|---|---|
| | Combustion | Burner Fuel | Feedstock | |
| Parameter | Air 126 | 24 | 28 | Primary Flame Gas 130 |
| Fluid type | Gas | Gas | Liquid | Gas |
| Gas flow, | 23,577 | 2,000 | 0 | 25,694 |
| Nm³/h | | | | |
| Gas flow, | 30,385 | 1,545 | 0 | 31,930 |
| kg/h | | | | |
| Temperature, | 500 | 20 | 280 | 2,078 |
| deg. C. | | | | |
| Liquid flow, | 0 | 0 | 6,800 | 0 |
| kg/h | | | | |
| Solid Flow, | 0 | 0 | 0 | 0 |
| kg/h | | | | |

| | Stream Name | | | |
|---|---|---|---|---|
| | Reaction stream | | | |
| | passing from reaction | Total | Tail Gas 138 to | Process Air |
| | zone 16 to first | Quench | Thermal | 126A to burn |
| Parameter | quench zone 18 | Water 22 | Oxidizer 40 | Tail Gas 138 |
| Fluid type | Gas + Solid | Liquid | Gas | Gas |
| Gas flow, | 34,948 | 0 | 61,472 | 38,367 |
| Nm³/h | | | | |
| Gas flow, | 34,689 | 0 | 56,010 | 49,383 |
| kg/h | | | | |
| Temp., | 1,509 | 20 | 230 | 0 |
| deg. C. | | | | |
| Liquid | 0 | 21,321 | 0 | 0 |
| flow, kg/h | | | | |
| Solid Flow, | 4,041 | 0 | 0 | 0 |
| kg/h | | | | |

| | | | Stream Name | | |
|---|---|---|---|---|---|
| | | Cooled flue | | Wastewater | Dewatered |
| | | gas 146 | Dewatered | 51 | flue gas 148 |
| | Hot Flue | exiting | flue gas | From | to CO₂ |
| Parameter | gas 142 | boiler 44 | 148 | dewatering | Capture 52 |
| Fluid type | Gas | Gas | Gas | Liquid | Gas |
| Gas flow, | 93,688 | 93,688 | 60,588 | 0 | 60,588 |
| Nm³/h | | | | | |
| Gas flow, | 105,393 | 105,393 | 78,787 | 0 | 78,787 |
| kg/h | | | | | |
| Temperature, | 1,093 | 230 | 40 | 40 | 40 |
| deg. C. | | | | | |
| Liquid flow, | 0 | 0 | 0 | 26,606 | 0 |
| kg/h | | | | | |
| Solid Flow, | 0 | 0 | 0 | 0 | 0 |
| kg/h | | | | | |

TABLE 8
Composition and properties of several key
gas stream for Comparative Example 3

| | Stream Name | | | |
|---|---|---|---|---|
| | Primary | | | Dewatered Flue |
| Composition | Flame | | Hot Flue | Gas 148 prior to |
| (vol. %) | Gas 130 | Tail gas 138 | Gas 142 | CO₂ Capture |
| N₂ | 71.75% | 29.99% | 52.07% | 80.52% |
| O₂ | 4.57% | 2.9E−10 | 1.99% | 3.08% |
| CO | 4.0E−03 | 8.83% | 0.00% | 0.00% |
| H₂ | 1.4E−03 | 11.18% | 0.00% | 0.00% |
| H₂O | 15.42% | 48.79% | 39.35% | 6.22% |
| CO₂ | 7.72% | 1.20% | 6.59% | 10.18% |
| CH₄ | 2.0E−18 | 1.9E−09 | 6.7E−30 | 0 |

In this comparative example, there will be 60,588 Nm³/h of dewatered flue gas to be processed in the CO₂ capturing unit. This gas stream contains 10.18 vol. % of CO₂ (Table 8).

### Example 4: HS (High Surface Area) Carbon Black Production According to an

### Exemplary Embodiment

In this Example 4, high surface area grade carbon black is produced using a process similar to that described in Example 2 but with a quench length of 1-10 m. The carbon black product processing, tail gas combustion, energy recovery and flue gas treatment generally follow the same protocol as shown in Example 2. The key process parameters for this Example are summarized in Table 9 below. Combustion of tail gas 38 results in about 39.3 MW of thermal energy, and a cooling duty of about 27.1 MW is required to dewater the scrubbed flue gas 46A.

TABLE 9
Key process parameters for Example 4

| | Stream Name | | | | |
|---|---|---|---|---|---|
| | | Dewatered | | | |
| | Oxidation | Flue Gas | Oxidation | Burner | |
| Parameter | Reagent 26 | 48A | Gas Mixture | Fuel 24 | Feedstock 28 |
| Fluid type | Gas | Gas | Gas | Gas | Liquid |
| Gas flow, | 5,043 | 10,206 | 15,249 | 2,129 | 0 |
| Nm³/h | | | | | |
| Gas flow, | 7,173 | 18,731 | 25,904 | 1,645 | 0 |
| kg/h | | | | | |
| Temperature, | 20 | 40 | 675 | 20 | 280 |
| deg. C. | | | | | |
| Liquid flow, | 0 | 0 | 0 | 0 | 6,800 |
| kg/h | | | | | |
| Solid Flow, | 0 | 0 | 0 | 0 | 0 |
| kg/h | | | | | |

| | Stream Name | | |
|---|---|---|---|
| | | Reaction stream passing | |
| | | from reaction zone 16 to | Total Quench |
| Parameter | Primary Flame Gas 131 | first quench zone 18 | Water 22 |
| Fluid type | Gas | Gas + Solid | Liquid |
| Gas flow, | 17,829 | 26,910 | 0 |
| Nm³/h | | | |
| Gas flow, | 27,549 | 30,308 | 0 |
| kg/h | | | |
| Temperature, | 2,119 | 1,510 | 20 |
| deg. C. | | | |
| Liquid flow, | 0 | 0 | 20,238 |
| kg/h | | | |
| Solid Flow, | 0 | 4040 | |
| kg/h | | | |

| | Stream Name | | | | |
|---|---|---|---|---|---|
| | | | Oxidation | | |
| | | | Reagent | Dewatered | Oxidation gas |
| | Total | Tail Gas 38 | 26A to | flue gas 48B | mixture to |
| | Quench | to Thermal | thermal | to Thermal | thermal oxidizer |
| Parameter | Water 22 | Oxidizer 40 | oxidizer 40 | oxidizer 40 | 40 |
| Fluid type | Liquid | Gas | Gas | Gas | Gas |
| Gas flow, | 0 | 52,087 | 7,149 | 29,584 | 36,733 |
| Nm³/h | | | | | |
| Gas flow, | 0 | 50,546 | 10,169 | 54,295 | 64,465 |
| kg/h | | | | | |
| Temp. | 20 | 230 | 20 | 40 | 37 |
| deg. C. | | | | | |
| Liquid | 20,238 | 0 | 0 | 0 | 0 |
| flow, kg/h | | | | | |

| | Stream Name | | | | |
|---|---|---|---|---|---|
| | | Cooled | | | Dewatered |
| | | flue gas 46 | | Wastewater | flue gas to |
| | Hot flue | exiting | Dewatered | 51 from | CO₂ Capture |
| Parameter | gas 42 | boiler 44 | flue gas 48 | dewatering | 52 |
| Fluid type | Gas | Gas | Gas | Liquid | Gas |
| Gas flow, | 82,511 | 82,511 | 47,200 | 0 | 7,410 |
| Nm3/h | | | | | |
| Gas flow, | 115,011 | 115,011 | 86,627 | 0 | 13,600 |
| kg/h | | | | | |
| Temperature, | 1,068 | 230 | 40 | 40 | 40 |
| deg. C. | | | | | |
| Liquid flow, | 0 | 0 | 0 | 28,384 | 0 |
| kg/h | | | | | |

TABLE 10
Composition and properties of several key gas stream for Example 4

| | Stream Name | | | | | |
|---|---|---|---|---|---|---|
| | Oxidation Gas | | | Oxidation | | |
| | Mixture to | Primary | | Gas Mixture | Hot | Dewatered |
| Composition | combustion | Flame | Tail | to Thermal | Flue | Flue |
| (vol. %) | zone 12 | Gas 131 | gas 38 | Oxidizer 40 | Gas 42 | Gas 48 |
| N₂ | 4.38% | 3.80% | 1.30% | 4.66% | 2.90% | 5.06% |
| O₂ | 34.45% | 7.55% | 0.00% | 21.74% | 2.03% | 3.55% |
| CO | 1.35E−06 | 4.15E−02 | 17.71% | 0.00% | 0.00% | 0.00% |
| H₂ | 6.73E−07 | 3.42E−03 | 6.52% | 0.00% | 0.00% | 0.00% |
| H₂O | 4.23% | 27.15% | 63.41% | 5.08% | 46.41% | 6.31% |
| CO₂ | 56.94% | 57.01% | 11.06% | 68.52% | 48.67% | 85.08% |
| CH₄ | 0 | 0 | 0 | 0 | 0 | 0 |

In this example, there will be 7,410 Nm³/h of dewatered flue gas to be processed in the CO₂ capturing unit. This gas stream contains 85.08 vol. % of CO₂ (Table 10).

### Example 5: HS (High Surface Area) Carbon Black Production According to an Exemplary

### Embodiment

In this Example 5, high surface area grade carbon black is produced using the same apparatus as in Example 4. Instead of pure oxygen, oxygen enriched air (containing 40 vol % O₂ and 60 vol % N₂) is used as the oxidation reagent 26A in thermal oxidizer 40. The oxidation reagent 26 contains 3 vol % N₂ and 97 vol % O₂. The carbon black product processing, tail gas combustion, energy recovery and flue gas treatment generally follow the same protocol as shown in Example 2. The key process parameters for this Example are summarized in Table 11 below. Combustion of tail gas 38 results in about 39 MW of thermal energy, and a cooling duty of about 29 MW is required to dewater the scrubbed flue gas 46A.

TABLE 11
Key process parameters for Example 5

| | Stream Name | | | | |
|---|---|---|---|---|---|
| | | Dewatered | | | |
| | Oxidation | Flue Gas | Oxidation | Burner | |
| Parameter | Reagent 26 | 48A | Gas Mixture | Fuel 24 | Feedstock 28 |
| Fluid type | Gas | Gas | Gas | Gas | Liquid |
| Gas flow, | 5,157 | 15,397 | 20,554 | 2,454 | 0 |
| Nm³/h | | | | | |
| Gas flow, | 7,363 | 24,593 | 31,956 | 1,896 | 0 |
| kg/h | | | | | |
| Temperature, | 20 | 40 | 676 | 20 | 280 |
| deg. C. | | | | | |
| Liquid flow, | 0 | 0 | 0 | 0 | 6,625 |
| kg/h | | | | | |
| Solid Flow, | 0 | 0 | 0 | 0 | 0 |
| kg/h | | | | | |

| | Stream Name | | |
|---|---|---|---|
| | | Reaction stream passing | |
| | | from reaction zone 16 to | Total Quench |
| Parameter | Primary Flame Gas 131 | first quench zone 18 | Water 22 |
| Fluid type | Gas | Gas + Solid | Liquid |
| Gas flow, | 23,474 | 32,525 | 0 |
| Nm³/h | | | |
| Gas flow, | 33,852 | 36,541 | 0 |
| kg/h | | | |
| Temperature, | 2,085 | 1,509 | 20 |
| deg. C. | | | |
| Liquid flow, | 0 | 0 | 22,160 |
| kg/h | | | |
| Solid Flow, | 0 | 3936 | |
| kg/h | | | |

| | Stream Name | | | | |
|---|---|---|---|---|---|
| | | | Oxidation | | |
| | | | Reagent | Dewatered | Oxidation gas |
| | Total | Tail Gas 38 | 26A to | flue gas 48B | mixture to |
| | Quench | to Thermal | thermal | to Thermal | thermal oxidizer |
| Parameter | Water 22 | Oxidizer 40 | oxidizer 40 | oxidizer 40 | 40 |
| Fluid type | Liquid | Gas | Gas | Gas | Gas |
| Gas flow, | 0 | 60,094 | 12,157 | 29,584 | 41,741 |
| Nm³/h | | | | | |
| Gas flow, | 0 | 58,701 | 16,496 | 47,254 | 63,746 |
| kg/h | | | | | |
| Temp. | 20 | 230 | 20 | 40 | 37 |
| deg. C. | | | | | |
| Liquid | 20,238 | 0 | 0 | 0 | 0 |
| flow, kg/h | | | | | |

| | Stream Name | | | | |
|---|---|---|---|---|---|
| | | Cooled | | | Dewatered |
| | | flue gas 46 | | Wastewater | flue gas to |
| | Hot flue | exiting | Dewatered | 51 from | CO₂ Capture |
| Parameter | gas 42 | boiler 44 | flue gas 48 | dewatering | 52 |
| Fluid type | Gas | Gas | Gas | Liquid | Gas |
| Gas flow, | 95,466 | 95,466 | 57,606 | | 12,625 |
| Nm3/h | | | | | |
| Gas flow, | 122,446 | 122,446 | | | 20165 |
| kg/h | | | | | |
| Temperature, | 1,027 | 230 | 40 | 40 | 40 |
| deg. C. | | | | | |
| Liquid flow, | 0 | 0 | 0 | 30,433 | 0 |
| kg/h | | | | | |

TABLE 12
Composition and properties of several key gas stream for Example 5

| | Stream Name | | | | | |
|---|---|---|---|---|---|---|
| | Oxidation Gas | | | Oxidation | | |
| | Mixture to | Primary | | Gas Mixture | Hot | Dewatered |
| Composition | combustion | Flame | Tail | to Thermal | Flue | Flue |
| (vol. %) | zone 12 | Gas 131 | gas 38 | Oxidizer 40 | Gas 42 | Gas 48 |
| N₂ | 28.92% | 25.37% | 9.91% | 39.01% | 23.29% | 38.60% |
| O₂ | 27.56% | 4.72% | 0.00% | 19.82% | 1.99% | 3.30% |
| CO | 0.00% | 3.14% | 15.02% | 0.00% | 0.00% | 0.00% |
| H₂ | 0.00% | 0.33% | 6.18% | 0.00% | 0.00% | 0.00% |
| H₂O | 4.73% | 24.71% | 59.77% | 4.47% | 43.46% | 6.31% |
| CO₂ | 38.79% | 41.73% | 9.13% | 36.70% | 31.25% | 51.79% |
| CH₄ | 0 | 0 | 0 | 0 | 0 | 0 |

### Example 6: HS (High Surface Area) Carbon Black Production According to an Exemplary Embodiment

In this Example 6, high surface area grade carbon black is produced using the same apparatus as in Example 4. A similar composition for oxidation reagent 26 and oxidation reagent 26A (3 vol % N₂ and 97 vol % O₂) is used in this example as in Example 4. This Example demonstrates the impact of higher moisture content in the dewatered flue gas 48 dewatered at 55° C. The key process parameters for this Example are summarized in Table 13 below. Combustion of tail gas 38 results in about 41 MW of thermal energy, and a cooling duty of about 29 MW is required to dewater the scrubbed flue gas 46A.

TABLE 13
Key process parameters for Example 6

| | Stream Name | | | | |
|---|---|---|---|---|---|
| | | Dewatered | | | |
| | Oxidation | Flue Gas | Oxidation | Burner | |
| Parameter | Reagent 26 | 48A | Gas Mixture | Fuel 24 | Feedstock 28 |
| Fluid type | Gas | Gas | Gas | Gas | Liquid |
| Gas flow, | 5,356 | 13,447 | 18,804 | 2,600 | 0 |
| Nm3/h | | | | | |
| Gas flow, | 7,648 | 23,978 | 31,626 | 2,008 | 0 |
| kg/h | | | | | |
| Temperature, | 20 | 55 | 676 | 20 | 280 |
| deg. C. | | | | | |
| Liquid flow, | 0 | 0 | 0 | 0 | 6,625 |
| kg/h | | | | | |
| Solid Flow, | 0 | 0 | 0 | 0 | 0 |
| kg/h | | | | | |

| | Stream Name | | |
|---|---|---|---|
| | | Reaction stream passing | |
| | | from reaction zone 16 to | Total Quench |
| Parameter | Primary Flame Gas 131 | first quench zone 18 | Water 22 |
| Fluid type | Gas | Gas + Solid | Liquid |
| Gas flow, | 21,984 | 31,059 | 0 |
| Nm³/h | | | |
| Gas flow, | 33,634 | 36,323 | 0 |
| kg/h | | | |
| Temperature, | 2,084 | 1,508 | 20 |
| deg. C. | | | |
| Liquid flow, | 0 | 0 | 22,161 |
| kg/h | | | |
| Solid Flow, | 0 | 3936 | |
| kg/h | | | |

| | Stream Name | | | | |
|---|---|---|---|---|---|
| | | | Oxidation | | |
| | | | Reagent | Dewatered | Oxidation gas |
| | Total | Tail Gas 38 | 26A to | flue gas 48B | mixture to |
| | Quench | to Thermal | thermal | to Thermal | thermal oxidizer |
| Parameter | Water 22 | Oxidizer 40 | oxidizer 40 | oxidizer 40 | 40 |
| Fluid type | Liquid | Gas | Gas | Gas | Gas |
| Gas flow, | 0 | 59,226 | 12,157 | 29,584 | 36,803 |
| Nm³/h | | | | | |
| Gas flow, | 0 | 58,964 | 16,496 | 52,752 | 63,111 |
| kg/h | | | | | |
| Temp. | 20 | 230 | 20 | 55 | 51 |
| deg. C. | | | | | |
| Liquid | 22,641 | 0 | 0 | 0 | 0 |
| flow, kg/h | | | | | |

| | Stream Name | | | | |
|---|---|---|---|---|---|
| | | Cooled | | | Dewatered |
| | | flue gas 46 | | Wastewater | flue gas to |
| | Hot flue | exiting | Dewatered | 51 from | CO₂ Capture |
| Parameter | gas 42 | boiler 44 | flue gas 48 | dewatering | 52 |
| Fluid type | Gas | Gas | Gas | Liquid | Gas |
| Gas flow, | 89,562 | 89,562 | 51,140 | | 8,109 |
| Nm3/h | | | | | |
| Gas flow, | 122,075 | 122,075 | | | 14,460 |
| kg/h | | | | | |
| Temperature, | 1,027 | 230 | 55 | 55 | 55 |
| deg. C. | | | | | |
| Liquid flow, | 0 | 0 | 0 | 30,855 | 0 |
| kg/h | | | | | |

TABLE 14
Composition and properties of several key gas stream for Example 6

| | Stream Name | | | | | |
|---|---|---|---|---|---|---|
| | Oxidation Gas | | | Oxidation | | |
| | Mixture in | Primary | | Gas Mixture | Hot | Dewatered |
| Composition | combustion | Flame | Tail | in Thermal | Flue | Flue |
| (vol. %) | zone 12 | Gas 131 | gas 38 | Oxidizer 40 | Gas 42 | Gas 48 |
| N₂ | 0.10% | 0.14% | 0.05% | 0.11% | 0.08% | 0.14% |
| O₂ | 30.98% | 4.93% | 0.00% | 22.52% | 1.99% | 3.49% |
| CO | 0 | 4.3% | 16.44% | 0.00% | 0.00% | 0.00% |
| H₂ | 0 | 0.4% | 5.52% | 0.00% | 0.00% | 0.00% |
| H₂O | 9.92% | 31.72% | 64.40% | 11.15% | 50.82% | 13.87% |
| CO₂ | 59.00% | 58.50% | 13.59% | 66.32% | 47.11% | 82.50% |
| CH₄ | 0 | 0 | 0 | 0 | 0 | 0 |

### Example 7: LS (Low Surface Area) Carbon Black Production According to an Exemplary Embodiment

In this Example 7, low surface area grade carbon black is produced using the same apparatus as in Example 2. Instead of pure oxygen, air is used as the oxidation reagent 26. Oxidation reagent 26A contains 3 vol % N₂ and 97 vol % O₂. The carbon black product processing, tail gas combustion, energy recovery and flue gas treatment generally follow the same protocol as shown in Example 2. The key process parameters for this Example are summarized in Table 15 below. Combustion of tail gas 38 results in about 28 MW of thermal energy, and a cooling duty of about 19 MW is required to dewater the scrubbed flue gas 46A.

TABLE 15
Key process parameters for Example 7

| | Stream Name | | | | |
|---|---|---|---|---|---|
| | Oxidation | Dewatered | Oxidation | Burner | |
| Parameter | Reagent 26 | Flue Gas 48 | Gas Mixture | Fuel 24 | Feedstock 28 |
| Fluid type | Gas | Gas | Gas | Gas | Liquid |
| Gas flow, | 13,358 | 5,704 | 19,061 | 318 | 0 |
| Nm³/h | | | | | |
| Gas flow, | 17,192 | 7,984 | 25,177 | 246 | 0 |
| kg/h | | | | | |
| Temperature, | 20 | 44 | 700 | 20 | 70 |
| deg. C. | | | | | |
| Liquid flow, | 0 | 0 | 0 | 0 | 7,000 |
| kg/h | | | | | |
| Solid Flow, | 0 | 0 | 0 | 0 | 0 |
| kg/h | | | | | |

| | Stream Name | | |
|---|---|---|---|
| | | Reaction stream passing | |
| | | from reaction zone 16 to | Total Quench |
| Parameter | Primary Flame Gas 131 | first quench zone 18 | Water 22 |
| Fluid type | Gas | Gas + Solid | Liquid |
| Gas flow, | 19,387 | 27502 | 0 |
| Nm³/h | | | |
| Gas flow, | 25,423 | 27,949 | 0 |
| kg/h | | | |
| Temperature, | 1051 | 1,339 | 20 |
| deg. C. | | | |
| Liquid flow, | 0 | 0 | 14,074 |
| kg/h | | | |
| Solid Flow, | 0 | 4,474 | |
| kg/h | | | |

| | Stream Name | | | | |
|---|---|---|---|---|---|
| | | | Oxidation | Dewatered | Oxidation gas |
| | Total | Tail Gas 38 | Reagent 26 | flue gas 48 to | mixture to |
| | Quench | to Thermal | to thermal | Thermal | thermal oxidizer |
| Parameter | Water 22 | Oxidizer 40 | oxidizer 40 | oxidizer 40 | 40 |
| Fluid type | Liquid | Gas | Gas | Gas | Gas |
| Gas flow, | 0 | 45,010 | 5,356 | 26,894 | 32,251 |
| Nm³/h | | | | | |
| Gas flow, | 0 | 42,023 | 7,619 | 37,648 | 45,267 |
| kg/h | | | | | |
| Temp. | 20 | 230 | 20 | 40 | 37 |
| deg. C. | | | | | |
| Liquid | 14,074 | 0 | 0 | 0 | 0 |
| flow, kg/h | | | | | |

| | Stream Name | | | | |
|---|---|---|---|---|---|
| | | Cooled | | | Dewatered |
| | | flue gas 46 | | Wastewater | flue gas to |
| | Hot flue | exiting | Dewatered | 51 from | CO₂ Capture |
| Parameter | gas 42 | boiler 44 | flue gas 48 | dewatering | 52 |
| Fluid type | Gas | Gas | Gas | Liquid | Gas |
| Gas flow, | 72,559 | 72,559 | 48,598 | | 16,000 |
| Nm3/h | | | | | |
| Gas flow, | 87,290 | 87,290 | | | 22,398 |
| kg/h | | | | | |
| Temperature, | 1,044 | 230 | 40 | 40 | 40 |
| deg. C. | | | | | |
| Liquid flow, | 0 | 0 | 0 | 19,260 | 0 |
| kg/h | | | | | |

TABLE 16
Composition and properties of several key gas stream for Example 7

| | Stream Name | | | | | |
|---|---|---|---|---|---|---|
| | Oxidation Gas | | | Oxidation | | |
| | Mixture to | Primary | | Gas Mixture | Hot | Dewatered |
| Composition | combustion | Flame | Tail | to Thermal | Flue | Flue |
| (vol. %) | zone 12 | Gas 131 | gas 38 | Oxidizer 40 | Gas 42 | Gas 48 |
| N₂ | 75.49% | 74.23% | 31.97% | 56.41% | 44.91% | 67.05% |
| O₂ | 15.33% | 11.75% | 0.00% | 18.01% | 1.52% | 2.27% |
| CO | 0 | 0 | 9.87% | 0.00% | 0.00% | 0.00% |
| H₂ | 0 | 0 | 11.03% | 0.00% | 0.00% | 0.00% |
| H₂O | 1.89% | 5.14% | 45.25% | 5.26% | 37.24% | 6.30% |
| CO₂ | 7.29% | 8.88% | 1.88% | 20.33% | 16.33% | 24.38% |
| CH₄ | 0 | 0 | 0 | 0 | 0 | 0 |

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. One of skill in the art will recognize that a wide variety of alternative system configurations are provided by the various embodiments described herein and depicted schematically in the figures. It is expected that the skilled artisan will be able to, with the benefit of the present disclosure, easily adjust the configuration and process parameters for desired operation of a furnace carbon black reactor according to the various embodiments of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method to produce carbon black, comprising:
(a) in a carbon black reactor comprising a combustion zone, at least one feedstock injection zone downstream of the combustion zone, and at least one reaction zone downstream of the first feedstock injection zone, converting in the reaction zone(s) a hydrocarbon feedstock to carbon black in the presence of combustion gases generated in the combustion zone by burning a fuel in an oxidation gas mixture comprising 20-85 vol % carbon dioxide, 15-80 vol % oxygen, at most 30 vol % water, and at most 35 vol % nitrogen to form a first product stream comprising carbon black, carbon dioxide, carbon monoxide, water vapor, and hydrogen, wherein the fuel is a portion of the hydrocarbon feedstock or a separate fuel source and wherein at least a portion of the hydrocarbon feedstock is contacted with the combustion gases in the at least one feedstock injection zone;
(b) adding water to the first product stream to at least partially halt the conversion and form a second product stream comprising carbon black, carbon dioxide, carbon monoxide, hydrogen, and water vapor;
(c) removing the carbon black from the second product stream to form a tail gas;
(d) decreasing the carbon monoxide and hydrogen content in at least a portion of the tail gas to produce a flue gas comprising at most 40 vol % nitrogen; and
(f) directing at least a first portion of the flue gas to at least one of the combustion zone, the at least one feedstock injection zone, and the at least one reaction zone.

2. The method of claim 1, wherein the first product stream further comprises sulfur-containing species, and the method further comprises removing at least a portion of the sulfur-containing species from the first portion of the flue gas, a second portion of the flue gas, or both.

3. The method of claim 1, wherein decreasing comprises combusting the tail gas, separating and recovering at least a portion of the hydrogen from the tail gas, or both.

4. (canceled)

5. The method of claim 3, wherein one or more of i) the first product stream and second product stream each contain carbon monoxide, and wherein decreasing further comprises combusting the tail gas following separating and recovering, ii) the method further comprises removing water from the tail gas prior to removing hydrogen, and iii) the method further comprises directing at least a portion of the tail gas to the combustion zone.

6. (canceled)

7. The method of claim 5, wherein the removed water is directed for use in step (b).

8.-10. (canceled)

11. The method of claim 1, further comprising combining the first portion of the flue gas with an oxidation reagent prior to directing, wherein the oxidation gas mixture comprises the combined first portion of the flue gas and oxidation reagent and wherein the combined portion of the flue gas and oxidation reagent are directed to the combustion zone, the reaction zone, or both.

12. The method of claim 11, further comprising one or more of i) heating the first portion of the flue gas before combining, ii) heating the combined first portion of the flue gas and the oxidation reagent, or iii) heating the first portion of the flue gas prior to directing.

13-14. (canceled)

15. The method of claim 1, further comprising combining the first portion of the flue gas with the hydrocarbon feedstock prior to directing, wherein the combined portion of the flue gas and hydrocarbon feedstock are directed to the at least one feedstock injection zone.

16. The method of claim 15, further comprising i) heating the combined first portion of the flue gas and hydrocarbon feedstock and/or ii) heating the first portion of the flue gas to form a hot flue gas and combining the hot flue gas with the hydrocarbon feedstock prior to directing.

17. (canceled)

18. The method of claim 1, further comprising i) heating the first portion of the flue gas with an energy source selected from a microwave, a plasma, and a resistive heating element; and/or ii) further comprising removing water from the first portion of the flue gas to produce a dewatered flue gas comprising at most 35 vol % water.

19-20. (canceled)

21. The method of claim 18, further comprising pelletizing at least a portion of the carbon black by combining the portion with a liquid, forming carbon black beads, and drying the carbon black beads to reduce the water content to at most 1 wt %, wherein drying comprises heating the dewatered flue gas and contacting carbon black beads with the heated dewatered flue gas.

22. (canceled)

23. The method of claim 18, further comprising diverting a portion of the dewatered flue gas and removing at least a portion of the carbon dioxide from the diverted dewatered flue gas.

24. (canceled)

25. The method of claim 18, further comprising providing the oxidizing gas by allowing liquid oxygen to evaporate, wherein the method further comprises transferring thermal energy from the dewatered flue gas to the liquid oxygen.

26. The method of claim 18, wherein removing the carbon black comprises i) passing the second product stream through a filter that separates the second product stream into carbon black and tail gas, wherein the method further comprises using the dewatered flue gas to purge solid particulates from the filter, or ii) passing the second product stream through a cyclone separator, wherein the method further comprises employing a portion of the dewatered flue gas to separate the tail gas and the carbon black in the cyclone separator.

27. (canceled)

28. The method of claim 18, further comprising compressing at least a portion of the dewatered flue gas and wherein i) removing the carbon black comprises passing the second product stream through a filter, wherein the method further comprises using the compressed dewatered flue gas to clean the filter; or ii) decreasing comprises combusting the tail gas in a burner, and the method further comprises using the compressed dewatered flue gas to clean the burner.

29-30. (canceled)

31. The method of claim 1, wherein adding water further comprises adding at least a portion of the first portion of the flue gas to the first product stream to halt the conversion.

32. Carbon black formed by the method of claim 1.

33. An apparatus for producing carbon black, comprising:
a carbon black reactor comprising a combustion zone for combusting an oxidation gas mixture and a fuel to generate a heated gas stream, a first feedstock injection zone for injecting a hydrocarbon feedstock into the heated gas stream to form a product stream, a first reaction zone in which carbon black is formed in the product stream, a first quench injector, and a first quench zone in which the carbon black is at least partially quenched with quench fluid injected from the first quench injector into the product stream;
a separator in fluidic communication with the first quench zone in which the carbon black is separated from the product stream to form a tail gas;
a thermal oxidizer configured to combust the tail gas with additional oxidation gas to form a hot flue gas;
a first flue gas heat exchanger that removes thermal energy from the hot flue gas and having an outlet to discharge a cooled flue gas; and
wherein the outlet is in fluidic communication with and upstream of at least one apparatus element selected from the combustion zone and the first reaction zone.

34. The apparatus of claim 33, further comprising a scrubber cooler comprising a sulfur-species scrubber and a water condenser, the scrubber cooler being configured to remove sulfur-containing species and water from at least a portion of the cooled flue gas, thereby producing dewatered flue gas, and comprising a discharge outlet through which the dewatered flue gas is discharged, wherein the discharge outlet is in fluidic communication with the at least one apparatus element.

35. The apparatus of claim 34, wherein one or more of i) the apparatus further comprises a heater in fluidic communication with the discharge outlet of the scrubber cooler and a carbon black pelletizer configured to receive at least a portion of heated dewatered flue gas from the heater, wherein the heated dewatered flue gas dries carbon black pellets formed in the pelletizer, ii) the separator comprises a bag filter and the apparatus is operable to direct at least a portion of the dewatered flue gas to periodically purge particulate solids from the bag filter, and iii) the apparatus further comprises a carbon capture system operable to remove at least a portion of carbon dioxide present in the dewatered flue gas.

36-37. (canceled)

38. The apparatus of claim 33, wherein one or more of i) the heat exchanger is a boiler in which thermal energy from the hot flue gas is transferred to water, ii) the apparatus is configured to combine at least a portion of the cooled flue gas with the additional oxidation gas and direct the combined portion of the cooled flue gas and additional oxidation gas to the thermal oxidizer, and iii) one or more of the combustion zone, the first reaction zone, and the first feedstock injection zone is configured to receive the oxidation gas mixture, wherein the oxidation gas mixture comprises at least a portion of the mass of the cooled flue gas and an oxidation reagent.

39. The apparatus of claim 33, further comprising one or more of i) a compressor configured to receive at least a portion of the flue gas from the outlet and discharge compressed flue gas, ii) a second quench injector and a second quench zone in which the at least partially quenched carbon black is further quenched with quench fluid injected from the second quench injector into the product stream, iii) a heater disposed between the outlet and the at least one apparatus element to heat at least a portion of the flue gas, the heater comprising a microwave source, a plasma source, or a resistive heating element, iv) a heat exchanger to receive the product stream from the first quench zone, wherein the heat exchanger is operable to exchange heat of the product stream with at least a portion of the cooled flue gas to heat the portion of the cooled flue gas to a temperature from 400 to 950° C.

40. The apparatus of claim 33, wherein the apparatus is configured to direct at least a portion of the tail gas to the combustion zone.

41. The apparatus of claim 40, further comprising one or more of i) a condenser upstream of the combustion zone configured to remove water from the portion of the tail gas; and ii) a hydrogen removal device upstream of the combustion zone configured to remove hydrogen from the portion of the tail gas.

42-47. (canceled)
